(19) United States
(12) Patent Application Publication
(10) Pub. No.: US 2010/0088240 A1
(43) Pub. Date: Apr. 8, 2010

(54) CONSTRUCTION COST ESTIMATING AND SCHEDULING SYSTEM AND METHOD

(76) Inventors: Andrew J. Ely, Wilton, CT (US); Radhakrishna Reddi, Kew Gardens, NY (US)

Correspondence Address: ST. ONGE STEWARD JOHNSTON & REENS, LLC, 986 BEDFORD STREET, STAMFORD, CT, 06905-5619, US

(21) Appl. No.: 12/496,417

(22) Filed: Jul. 1, 2009

Related U.S. Application Data
(60) Provisional application No. 61/077,420, filed on Jul. 1, 2008.

(51) Int. Cl. G06Q 10/00; G06Q 50/00

(52) U.S. Cl. 705/301; 705/348

(57) ABSTRACT

A computer system for determining an escalated estimated project cost and an estimated schedule for a project including a plurality of activities having a plurality of cost items. The computer system is operable to determine: a critical path for the project based on the amount of critical days to include on the critical path for each activity, a pre-escalation cost for each cost item of each activity, a pre-escalation cost for each activity, a pre-escalation total project cost, a cost escalation for each activity, a cost escalation for the project, and an escalated estimated cost of the project, and the computer system is operable to generate a report of the pre-escalation total project cost, the escalated estimated project cost, and the estimated project schedule based on the critical path.

### CROSS-REFERENCE TO RELATED APPLICATIONS

The present application claims the benefit under 35 U.S.C. §119(e) of the U.S. Provisional Patent Application Ser. No. 61/077,420, filed on Jul. 1, 2008, the content of which is incorporated herein by reference.

### FIELD OF THE INVENTION

The invention pertains to the field of cost estimating and scheduling and, in particular, to project cost estimating and scheduling systems and methods.

### BACKGROUND OF THE INVENTION

When contractors bid on a project, including a construction project, it is essential that they have a good cost estimation and project schedule. Many contractors determine the cost estimate and then determine a project schedule separately. Further, the tasks of determining the cost estimate and project schedule often fall on different personnel within an organization, and often estimators do not have a complete understanding of scheduling and schedulers have little knowledge of cost estimating. As a result, software companies have developed separate cost estimating scheduling software applications. However, the bifurcated approach to cost estimation and scheduling is problematic because it is often results in inaccurate results for the cost estimate, or schedule, or both.

### SUMMARY OF THE INVENTION

The system and method of the present invention is a computer software based solution particularly suitable for infrastructure contractors and other individuals who are involved in estimating the cost and duration of large-scale projects. The invention provides an integrated solution that offers both cost estimating and project scheduling.

Preferably, the system is embodied in a windows-based computer program application having a professional, ergonomic user interface that is intuitive and easy to navigate.

To advantage, the application includes comprehensive and customizable reports providing various summary and detailed reports with built-in data search capabilities (e.g., “drill-down” functionality). Further, users can preferably convert reports to various formats such as Portable Document Format (pdf), Excel, Rich Text Format (rtf), Hypertext Markup Language (html), and other formats.

Further, the application preferably allows users to export and import data from the application into various file formats while offering data import facilities from other applications and data files, e.g., Import Labor Rates, Tax Rates, Multiplier Tables, etc.

The system can support multiple currencies with the same project and allows multiple holiday calendars to be used for different locations within a project, for different location costs. The system automatically converts project cost from one currency to another based on exchange rate data.

Project data is stored in files which allows users to create an unlimited number of projects. The user may create a new project or modify an existing project, and can protect a project with a password.

The system provides a project summary display (e.g., on a computer monitor) with the ability to “drill-down” to project details (e.g., bid items and activities there-under), which summary is in a tree-like hierarchical structure with costs organized by Location, Bid Item, Activity and down to individual items, including labor, equipment, small tools, materials, etc.

The system provides various look-up tables for ease of data entry. Data entry screens include bid items, equipment, materials, labor, activities, etc. Many fields are automatically populated from calculations and some are selected from drop-down look-up tables.

A scheduling chart allows users to create new activities and assign predecessor and successor activities to influence how the application determines the critical path and duration of the project.

Also, the application preferably provides comprehensive, context-sensitive help on various screens which shows relevant help information based on the current screen selection.

The invention provides an integrated project cost estimation and scheduling system and method that allows a project manager to simultaneously and efficiently determine an accurate estimated cost and project schedule of any project. The invention is of particular benefit to managers of large-scale projects involving a vast number of inter-dependent and independent activities, such as in construction (large or small, new or changes), movie production, and any project involving multiple, inter-dependent activities the ultimate costs of which are influenced by the duration and scheduling or sequencing of the project and its components.

### BRIEF DESCRIPTION OF THE DRAWINGS

For a complete understanding of the above and other features of the invention, reference shall be made to the following detailed description of the preferred embodiments of the invention and to the accompanying drawings, wherein:

FIG. 1 is a flow diagram of the invention;

FIG. 2 is a schematic of the data items utilized by the invention;

FIG. 3 is a flow diagram of entering or modifying project data;

FIGS. 4A-4C show a sample project cost estimate produced by the invention;

FIG. 5 is a sample calculation of a project escalation factor;

FIGS. 6A-6I, 7A-7F, 8A-8B and 9A-9C depict another project showing a bar graph of the project schedule;

FIG. 10-16 show various reports which the system can generate;

FIG. 17 is a control panel for modifying escalation curves.

### DETAILED DESCRIPTION OF THE INVENTION

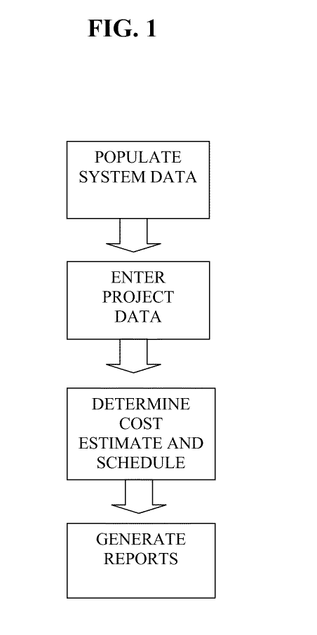

Referring to FIGS. 1-5, the present invention provides an integrated system and method for obtaining highly accurate project cost estimates and schedules. Preferably, the system is implemented via a computer system, such as one or more general purpose personal computer systems or other computing devices, having specialized programming.

Referring to FIG. 1, the method includes a first step of populating the system with data necessary or expedient to producing cost estimates and schedules. Next, the user enters and/or modifies project-specific information. After entry of the project-specific information, the system determines the estimated project cost and determines the project schedule. Upon determination of the estimated project cost and schedule, the user may direct the system to generate reports.

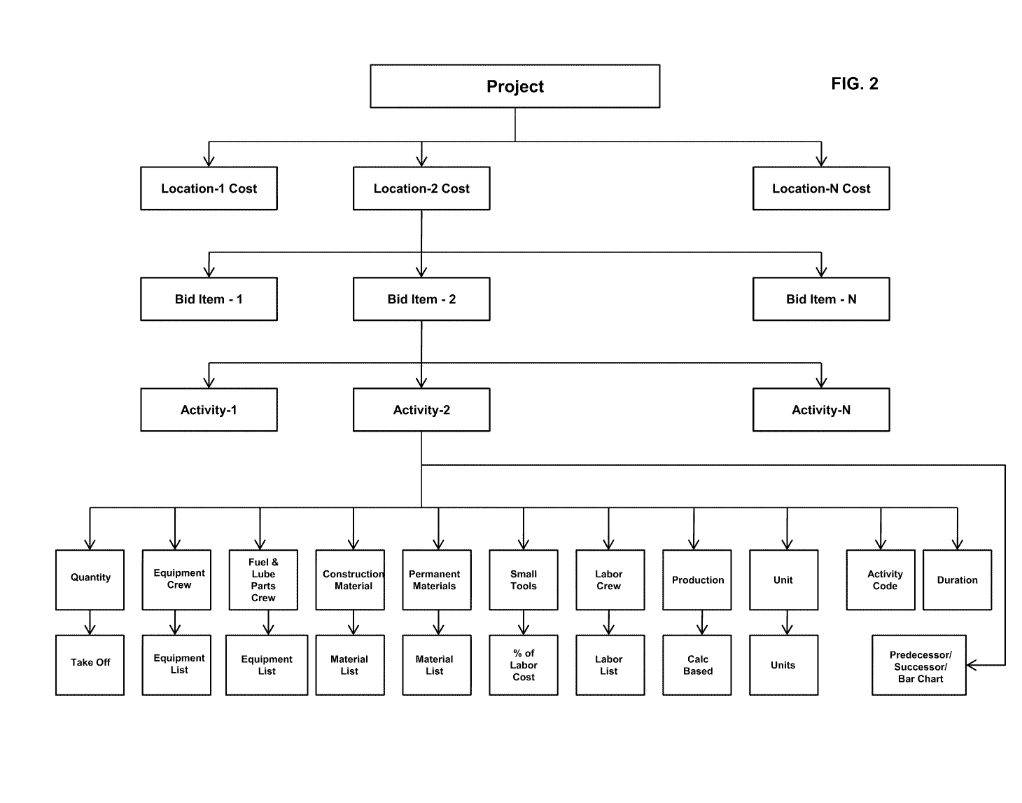

Referring to FIG. 2, the project data items for a particular project employed by the system are preferably organized in a hierarchical structure. As an example, for a construction project, at the top is the entire Project, which may include one or more Locations, such as Tunnel 1, Tunnel 2, etc. Each location will typically have many Bid Items, such as Excavate Starter Tunnel and Excavate Tail Tunnel, etc. Further, each Bid Item will often have a large number of Activities. Other types of projects may have different structures for data items.

Each Activity will have a number of cost items, such as equipment, labor and/or materials cost item. Each activity in a Bid Item may have a different start date and/or end date, however all of the cost items associated with a particular Activity preferably have the same start and end date.

In particular, each Activity will typically have a predetermined (fixed) Code, a Quantity value, a Unit designation (such as Bank Cubic Yards, or BCY), and a Duration value. The Activity may also have a Production value (e.g., units/day), a Labor Crew set, an Equipment Crew set, a Fuel & Lube Crew set, a Construction (or “Job”) Material set, a Permanent Materials set, and/or a Small Tools set.

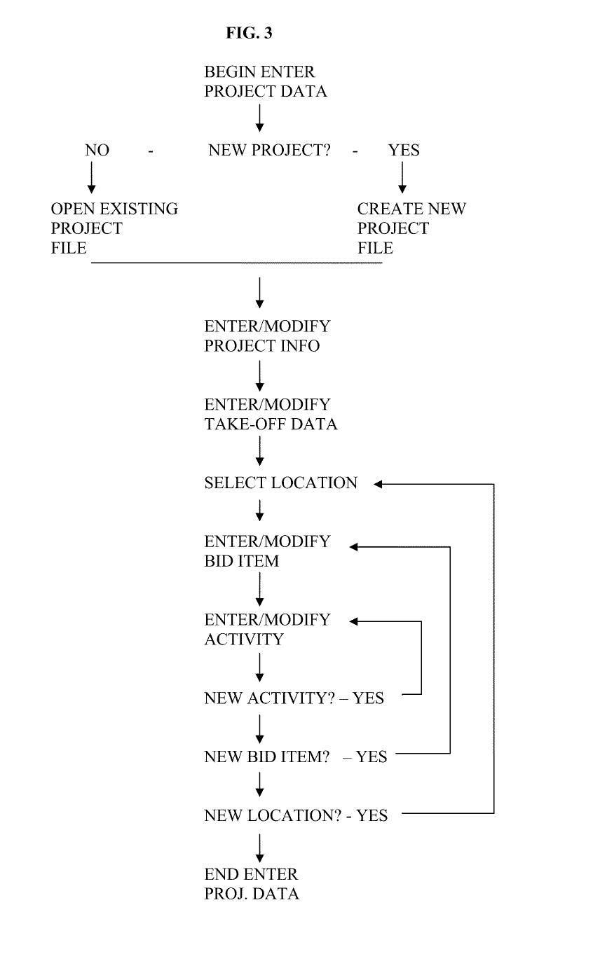

Referring to FIG. 3, the system preferably provides for the entering or modifying of project-specific data by a user. Using the example of a construction project, the system preferably provides for indicating whether the project is a new or existing project. If the user indicates that the project is new, the system preferably prepares to create a new project and prompts the user to enter general project information such as the project name, the number of and name(s) of the locations in the project, and the start date. If the user requests an existing project, the system preferably opens the existing project file and provides means for the user to modify such general project information.

After the general project information is entered or modified, the system preferably provides for the user to enter or modify take-off data about the project. Quantity take-off is one of the most time consuming and error prone activities of large-scale infrastructure project cost estimation and scheduling. Most often, quantities will be taken manually with the use of drawings and the project specification. However, preferably, the system provides for importing take-off data electronically from other computer applications, including Computer-Aided-Design (CAD) applications.

The system also preferably permits the user to enter Bid Items and Activity information for each Location. As depicted, the system may prompt the user to select a Location, and then prompt the user to enter or modify a Bid Item for the selected Location. Upon entry or selection of a Bid Item, the system may prompt the user to enter or modify an Activity for the Bid Item. Upon completion of the entry of Activities for a Bid Item, the system may prompt the user to enter or modify another Bid Item. Likewise, upon the completion of the entry or modification of Bid Items for a Location, the system may prompt the user to enter or select another Location. If the user does not wish to make further entries or modifications to Locations, the system may then proceed to determine the estimated cost and schedule and then permit the user to generate reports, as indicated in FIG. 1.

Preferable Bid Items may be entered manually or selected from a drop-down list of pre-defined Bid Items. Also, if a user selects a pre-defined a pre-defined Bid Item, the system preferably populates the Bid Item with one or more pre-defined Activities associated with the selected Bid Item. Each pre-defined Activity has a number of pre-determined cost items. In this manner, the user can rapidly and accurately enter commonly-used Bid Items and Activities.

While the above example is most suitable to a construction project, the flow may also be appropriate for other types of projects. For other types of projects, instead of entering quantity take-off, the flow may include obtaining units requiring operation until completion, which may, for example, include the number of hours of film needed to be shot (for a movie production project), or some other quantity.

### Sample Estimate

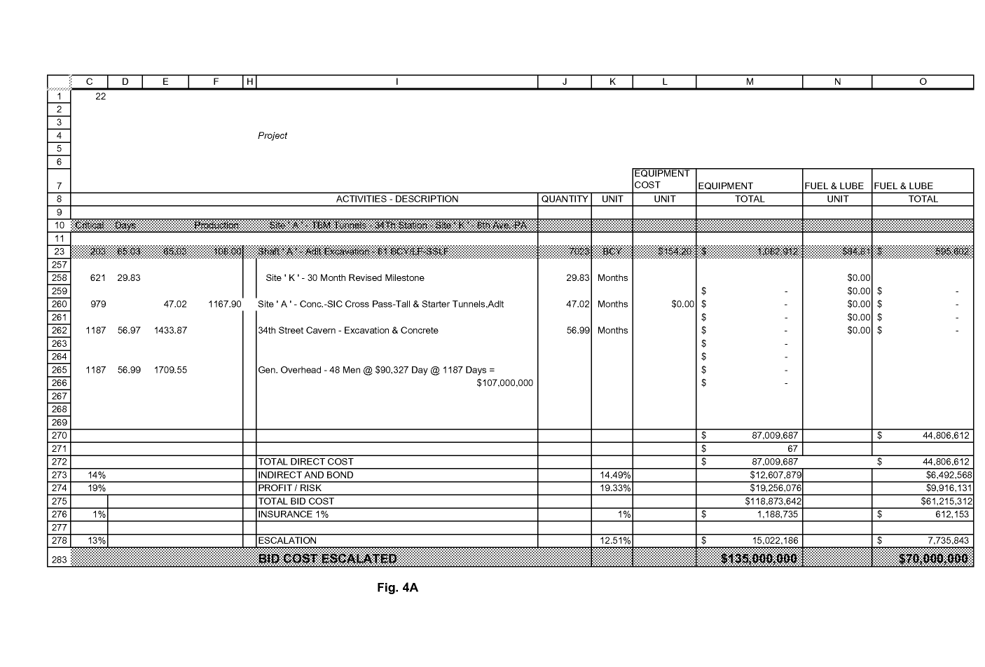

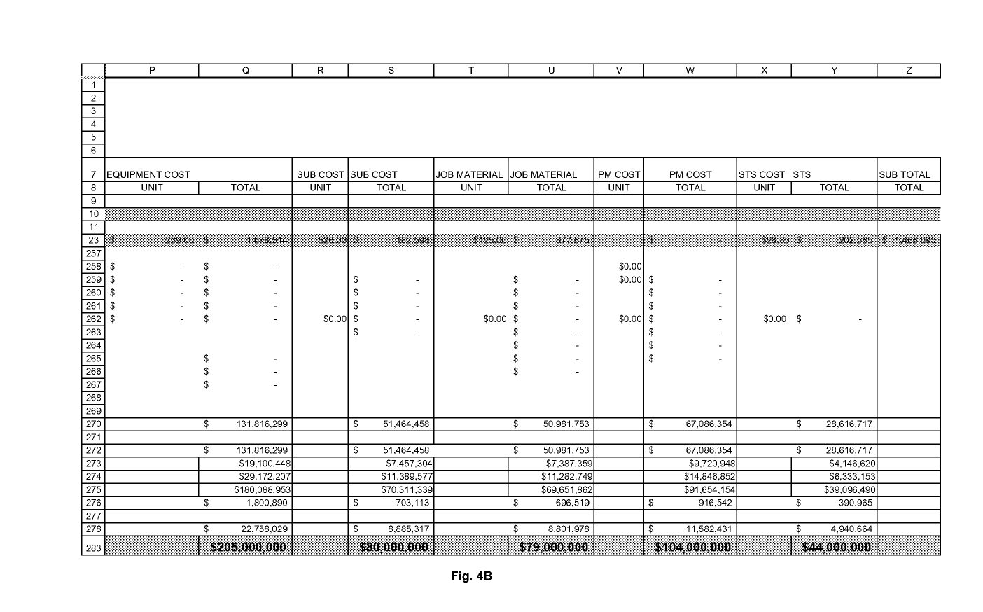

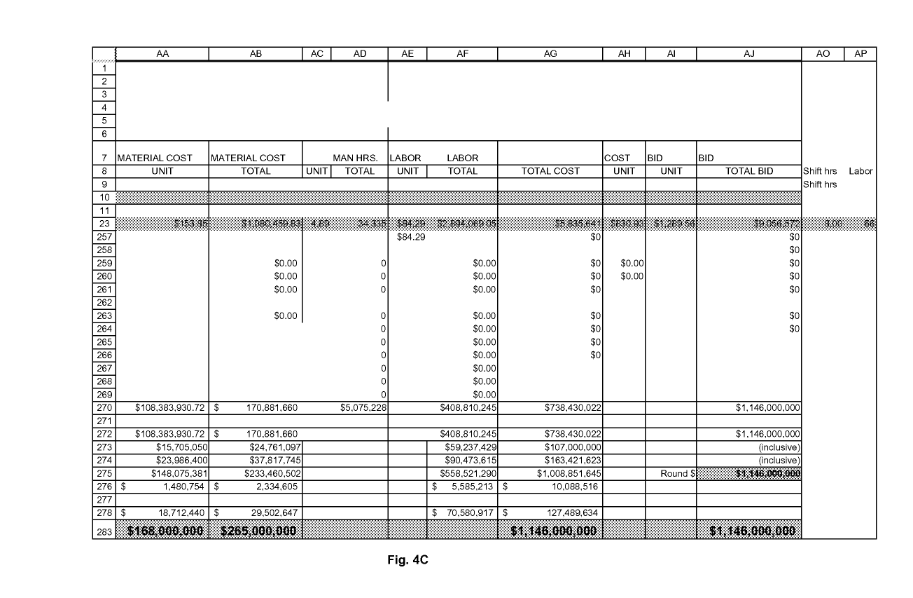

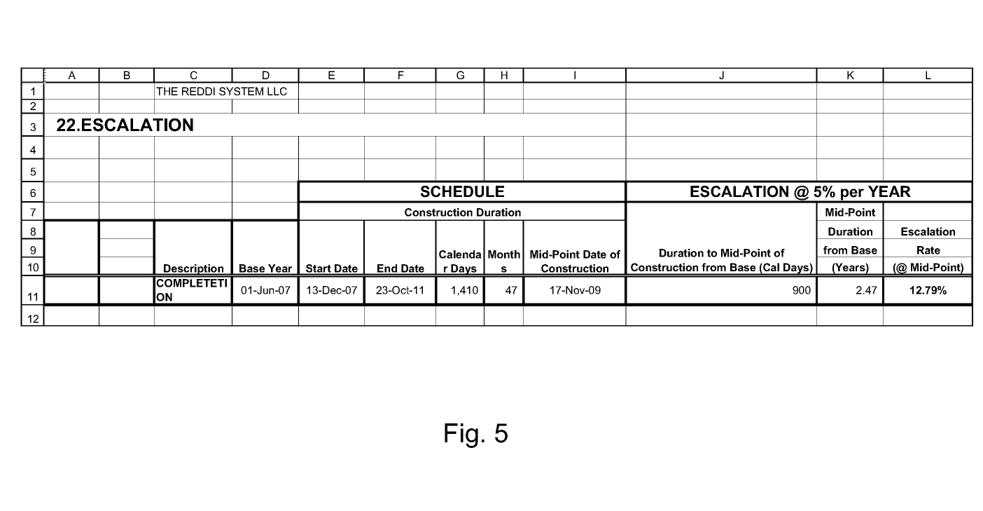

Referring to FIG. 4A-5, a sample cost estimate having a portion of a full estimate is shown to illustrate the cost estimation provided by the present invention. While this example is illustrated with an embodiment implemented with a computer spreadsheet, it will be appreciated that the system and method are similar for embodiment implemented in a stand-alone computer application.

All Activities taken off by the estimating team are placed in column (I), Quantities are placed in column (J), and Units in column (K), such as Lump Sum Bid Items (LS), Units such as bank cubic yards BCY) in place, and Units like cubic yards (CY), such as concrete, earth excavation, shot rock, gravel, sand, stone—sometimes referred to as lose cubic yards (LCY) not in place, truck hauling of all of the above mentioned items for payment by the CY, labor man hours (MH's), small tools (STS) are all items costing less than $4000, job materials (JM) contractors supplies not paid for by the owner of the project site but in the cost of the Activity. Permanent Materials (PM), incorporated into the work and paid for by the owner.

Activities fall under Column (I) Shaft ‘A’—Adit Excavation. Quantities under Column (J) showing a total of 7,023 BCY. The Contractor decides that he can excavate 108 BCY a day, in three shifts. The number 108 is entered into Column (F) which is automatically divided into the Quantity in Column (J), 7,023 BCY, then Column (E)=J23/F23 which (E) automatically records a 65 work days. Column (D) is the Chief Estimators sole decision to decide if all 65 days are to be placed on the Critical Path, or a part of the 65 days are placed on the Critical Path or none of the 65 days are on the Critical Path. If the Chief Estimator decides that all 65 days in Column E are Critical Path then the formula placed in Column D is (D=E23) and automatically Column C, Critical Path, has 65 days added to the Schedule.

These decisions by the Contractor's Chief Estimator will decide the success or failure of their Company. The Chief Estimator must have at least 10 years of actual field experience in the types of contracts his company has chosen and must have complete control in guiding his team to the end results of the estimate. He will then explain his means and methods and how he arrived at his results to the principles of his company and they must evaluate the risks and decide to Bid the Project and what their margins should be. Be it 20% of Costs or 40% of Labor. If a Joint Venture has been form they will go with understanding of their Bid and here what their partners have come up with.

To explain how does Line 23, Column (D) get to Column (C), the Critical Path Column, in our sample Line 23 has a total of 203 days shown in Column (C) with the 65 days included. On Line 23 Column (C) the Contractor's Estimators clicks on Line 23 Column (C) and enter a formula which is Line C22+D23 equals 203 Days.

Regarding estimating equipment and fuel and lube, Column (J) shows a quantity of 7,023 BCY. The Contractor's Estimators have concluded that the equipment required for this activity has a rental cost of $16,653 per day. Each piece of equipment and its' cost per day are located by referring to a look-up table for the Activity, which may be accessed by clicking the Equipment Tab at bottom of the spread sheet (if as here the system is implemented in a spreadsheet). Column (J) 7,023 BCY is then divided into $16.653 to arrive at a factor of $2.37 cost for each of the 7,023 BCY which is found on Line 23. Column (AM).

Column (L) has a cost unit of $154.20 which was arrived at by Formula=E23*AM23 and by using Column (J) 7,023 BCY and a Formula=+$J23*L23 gives Column (M) a total cost of $1,082,912. As the calculated factor of $2.37 per BCY in Column (AM) was reached all Units and total costs for Contractors rental equipment are automatically reached.

Column (N), Fuel-Lube & Parts, has a predetermined cost factor of $0.55 times the cost Unit in Column (L), 154.20 to arrive at a cost Unit in Column (N) of $84.81 for Formula (=L23*0.55). Column (0). is the Total Cost for Fuel-Lube & Parts. $595.60, Formula (=+$J23*N23).

Equipment and Fuel-Lube & Parts are calculated in a similar fashion and once you enter the equipment unit, Column (L), Columns M.N.O.P & Q are completed automatically for a total of $1,668.514.

Regarding subcontractors, line 23 Column (R) is the Unit & Column (S) Total Cost of the subcontractor's proposal. Subcontractors could be electrical contractors, mechanical contractors or a trucking contractor hauling excavated earth or rock and minority subcontractors getting a percentage of contracts by law such as MBE & WBE or MWBE contractors.

Materials costs are in Job Material column ‘T’ units and column ‘U’ cost, and Permanent Material column ‘V’ units and column ‘W’ costs. Job Materials (JM) are items that the owner has a general understanding of but has little knowledge of how many items are required or their costs. The Contractor covers all his costs such as deliveries of explosives, blasting caps, drill steel, bits, drill parts, blasting mats, ventilation, air, water, discharge, lines, rails, ties, lighting, conveyors are necessary to build the project.

Permanent Material column ‘V’ units and column ‘W’ costs are materials required by the Contract documents to be incorporated in the work and are paid for by a lump sum basis or by bid units. Columns ‘V’ units and ‘W’ PM are priced the same as JM except many PM items carrier a warranty to the Owner for a number of years and a contingency may be built into this item.

Regarding labor costs, columns “AO” and “AP” are two of the most critical columns in the estimating process. “AO” is the hours a worker is paid (8 hours) for a 7.5 hour work day. The “AP” column is the most critical of all the labor Columns. The decision by the Chief Estimator to have the right number of men for each Activity and the proper productions in Column “F” is the Catalyst for a successful Project or a Failure.

All costs above Line 270 are Direct Costs and all Cost below Line 270 are Indirect Costs. Column ‘AG’, Line 272, is total Direct Costs. Column “AG”, Line 273 is Total Indirect Cost & Bond, ‘AG’ Line 274 if Profit/Risk, ‘AG’Line 275 is total Bid Cost, ‘AG’ Line 276 is Insurance, ‘AG’ Line 278 is Escalation and ‘AJ’ Line 283 is Bid.

All of the above items, Line 270 thru Line 283, will adjust with the change of any Direct Item.

Determining the escalation of costs is one of the most critical aspects of obtaining an accurate cost estimate. The system estimates the cost escalation using a formula based on the duration of the project, the start date of the project and a base date for the initial cost estimates. The base date is a reference date upon which the costs comprising the pre-escalation total bid costs are based.

Referring to FIG. 5, if a project has a base date of Jun. 1, 2007, a start date of Dec. 13, 2007 and an end date (determined by the system) of Oct. 23, 2011, a duration (also determined by the system) of 47 months, then the system determines that the duration from the base date to the mid point of the project is 2.47 years. Using a predetermined period escalation factor of, for example 5%, the project escalation rate will be 12.79%, which is 2.47×5%.

It can be appreciated that there are other suitable methods for determining an escalation rate for the project. However, to be accurate, the escalation rate must be based, at least in part, on the duration of the project.

The escalation is found in Column “AG” Line 278 which is triggered by the Total Bid cost of Column “AG”, line 275 plus the Total Insurance in column “AG”, line 276, times Column “K”, line 278, 12.37%.

The key items on this chart are found on Line 272 of the Estimate for Direct Costs and Line 273 and Line 274 & Line 276 & Line 278 for all Indirect Costs to give you a $1.146.429.795 Bid.

Most preferably, the system computes the escalation separately for every activity in the project, based on the start and end dates of the activity and the base date used in determining costs for the activity. The system then adds the escalation cost for each activity to the total cost. The system may also sum just the escalation costs for all of the activities to compute a total escalation cost.

Preferably, the system calculates the escalation cost for each activity individually using a mid-point escalation formula as described above. Specifically, the system determines the mid-point date of the activity based on the scheduled start and end dates of the activity, and then determines the duration from the base date used for the project to the mid-point of the activity. The duration to the mid-point is used to multiply a pre-determined escalation factor to arrive at an escalation rate for the activity. All of the costs related to an activity are multiplied by the escalation factor for the activity to determine an escalation cost for each activity.

The process of determining escalation costs on a per-activity basis provides for increased accuracy in determining total escalation costs, especially if activities are not substantially evenly distributed over a total duration of a project.

While cost escalations are most often the result of cost inflation over time, other factors can affect the costs of goods and services over the lifetime of a project. Therefore, the system preferably provides for computation of other alterations of pricing based on the scheduling and sequencing of activities, such as seasonal price fluctuations and other non-inflation related pricing alterations.

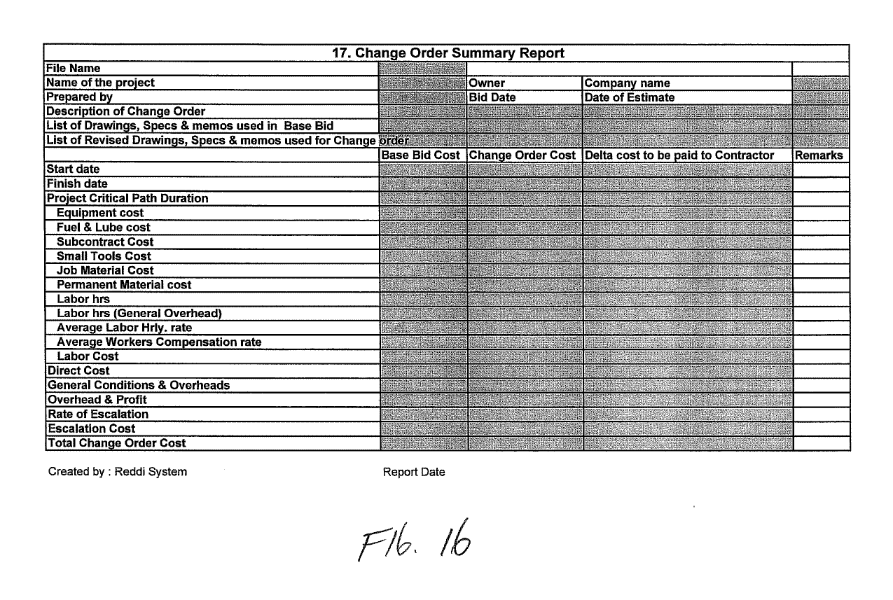

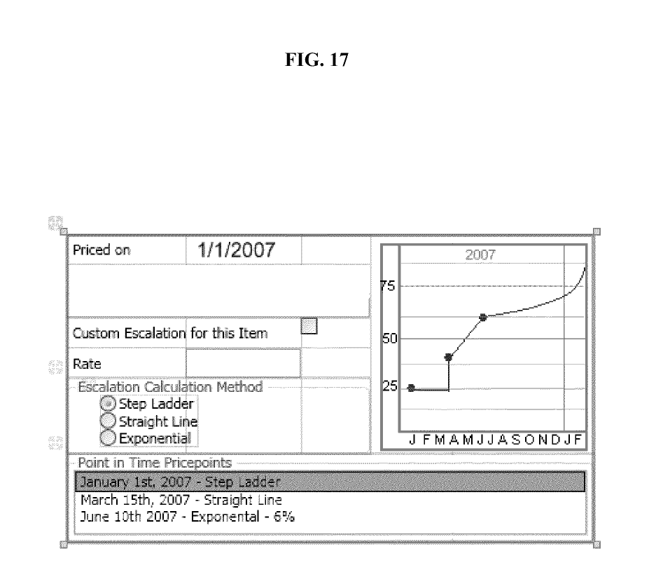

Referring to FIG. 17, the system preferably permits users to create customized escalation curves for any cost item in a project which provides the ability to price resources at the time of their consumption based upon estimated inflation. Inflation is typically called “Escalation” in the construction industry. A default (or global) inflation/escalation rate is also preferably provided in the event that the user does not specify a rate for a particular cost item. The control panel depicted in FIG. 16 is a suitable means to for producing inflation curves.

The actual price information may be set in a panel that is specific to the type of resource. For any given point in time, a different set of price information can be specified. If custom escalation is not selected the price at a given point is preferably calculated using the global percentage escalation, and controls to add additional price points may be inoperable (e.g., “grayed out”).

If custom escalation is selected the system preferably allows the user to adjust the rate, and add multiple price points at different times. To compute the price in-between any two points in time, the system preferably provides several methods, such as stepladder (flat until the price increase), straight line (constant rate of increase), or exponential (e.g., compounded) calculation methods.

Using the curve depicted in FIG. 17 as an example, the base date for the price is the “Priced on” date of Jan. 1, 2007. A project manager may anticipate that the cost item will have a known, fixed price for an initial period of time (Jan. 1, 2007 until Mar. 15, 2007), at which time the manager anticipates that the cost will increase to a second (higher) known amount. For a second period of time (until Jun. 10, 2007), the manager may anticipate that the cost will increase at a constant rate (straight line). Thereafter, the manager may anticipate that the cost will increase at an exponential (e.g., compounded) rate.

Using the specified cost curve the system calculates the price for that resource over the duration of the activity/cost item, for example by performing a Riemann Sum, to find the area under the price curve by slicing it up and summing the area of the slices.

Cost items associated with particular Activity have the same duration and sequence and can be summed together prior to calculated the escalation for each cost item, if each cost item has the same escalation curve. However, to the extent that cost items within a particular Activity have different escalation curves, the escalation costs for those cost items are preferably calculated separately and then summed to arrive at a total cost escalation for the particular Activity.

Alternate Sample Estimate and Schedule

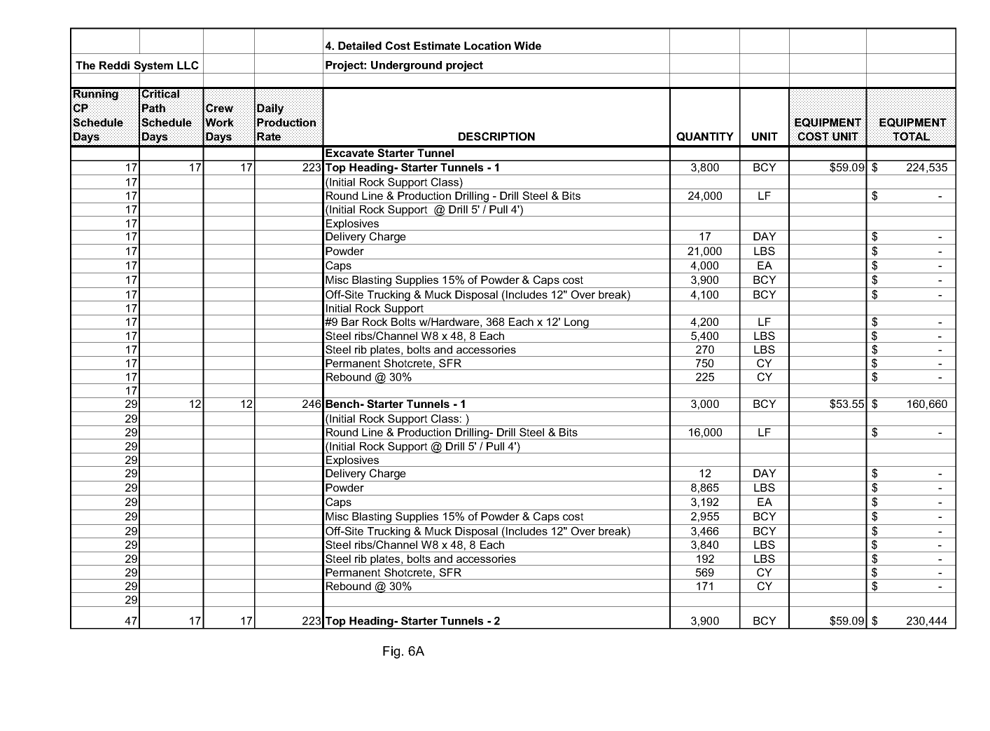

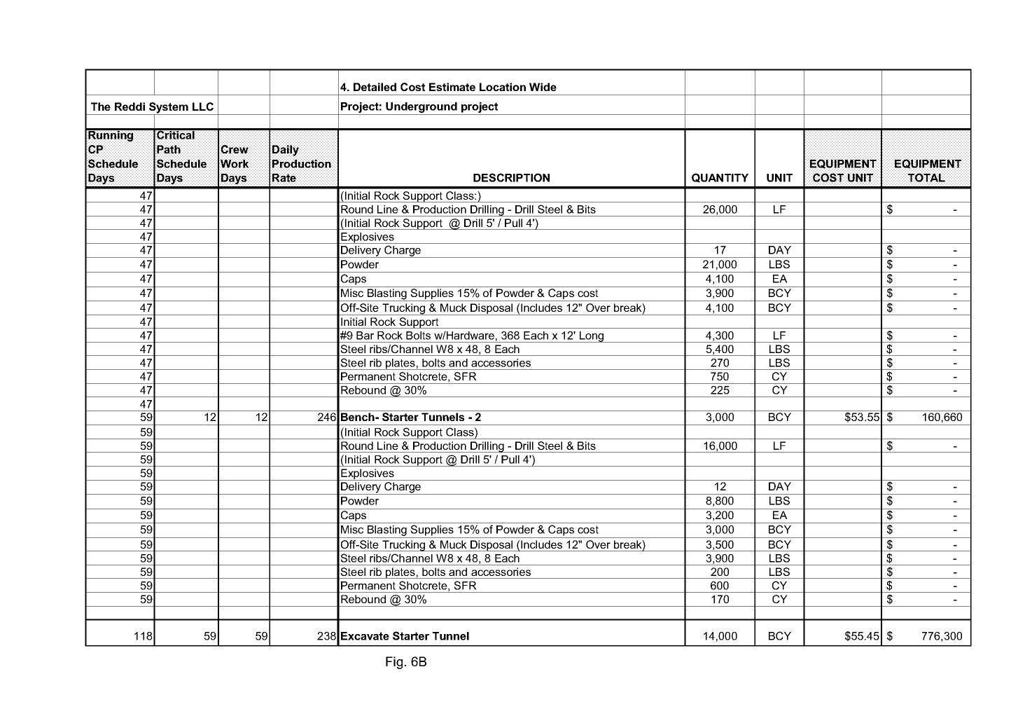

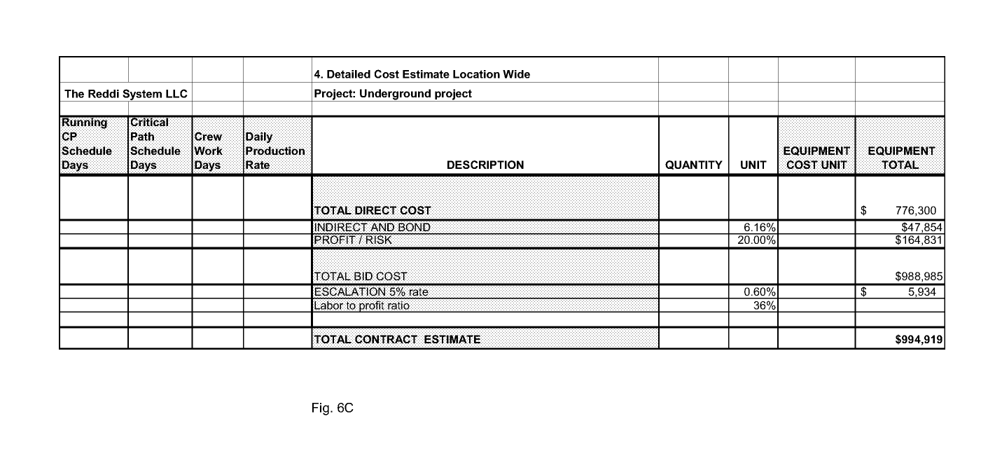

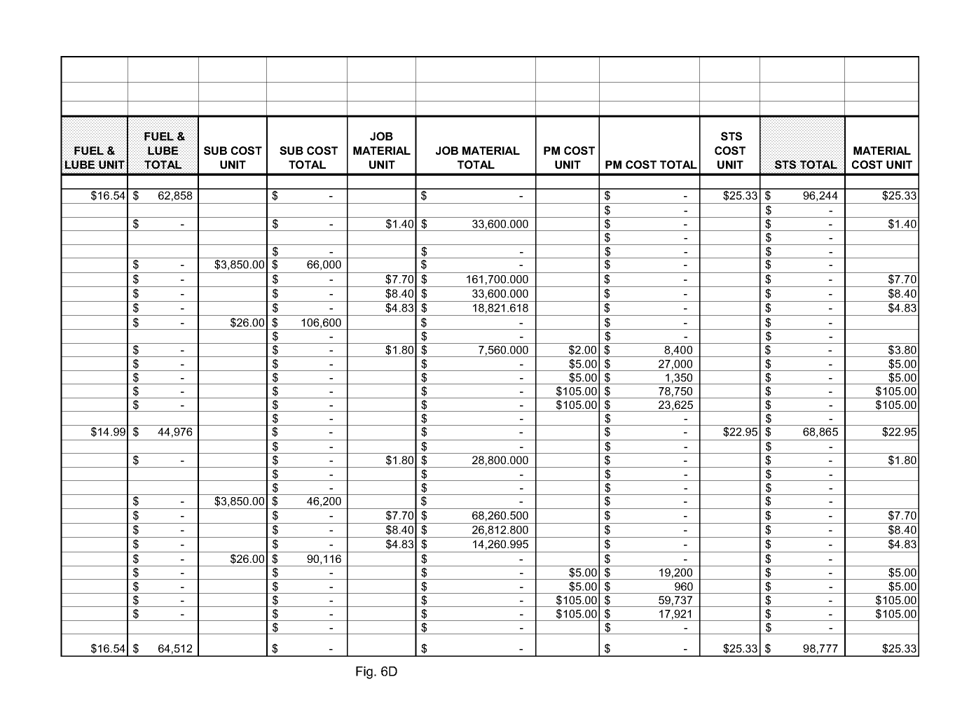

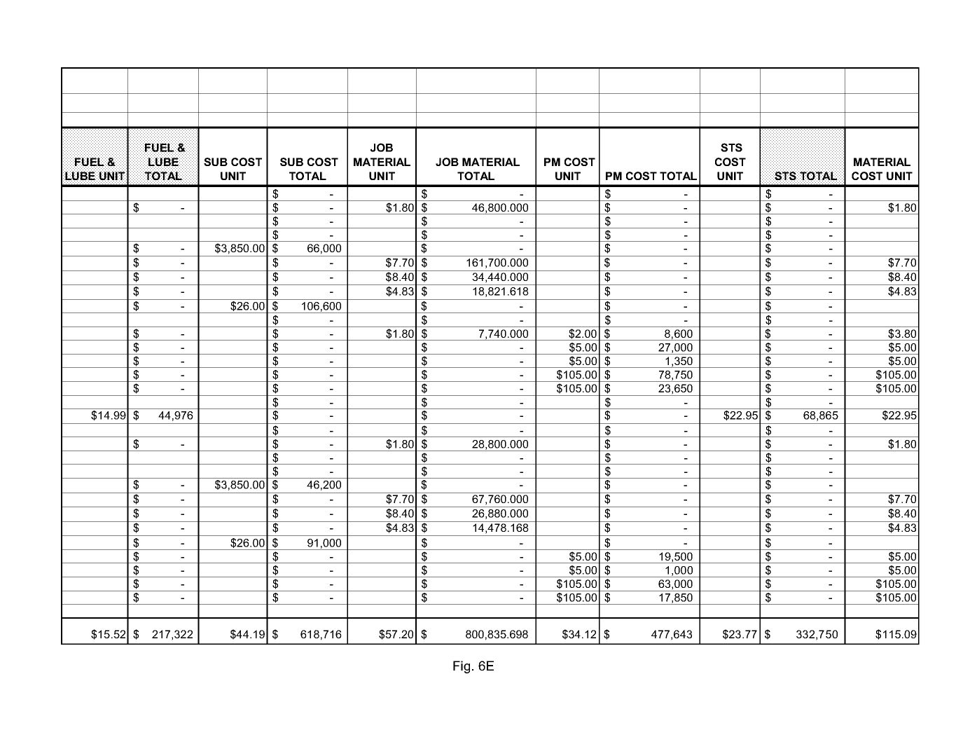

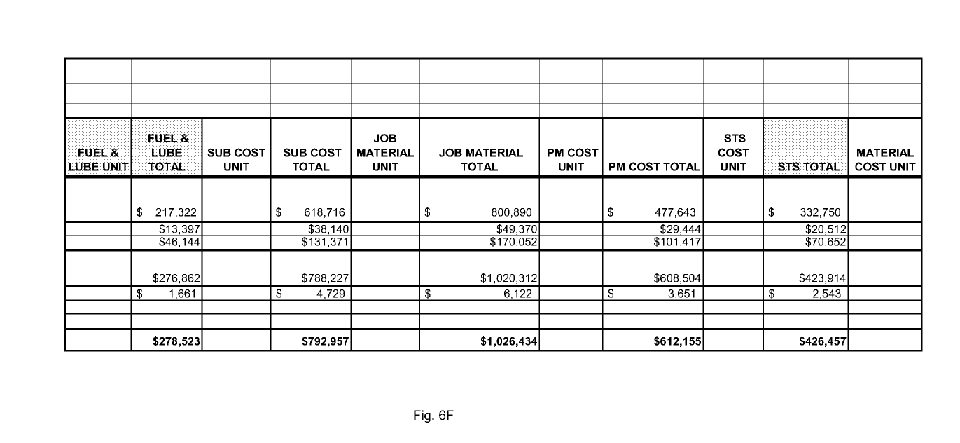

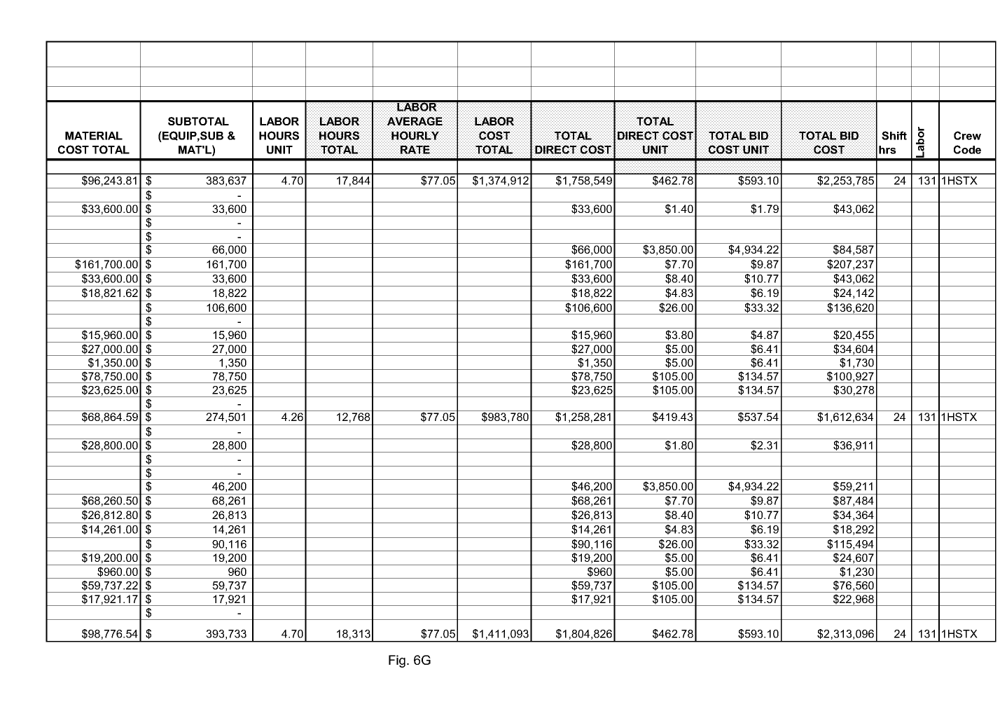

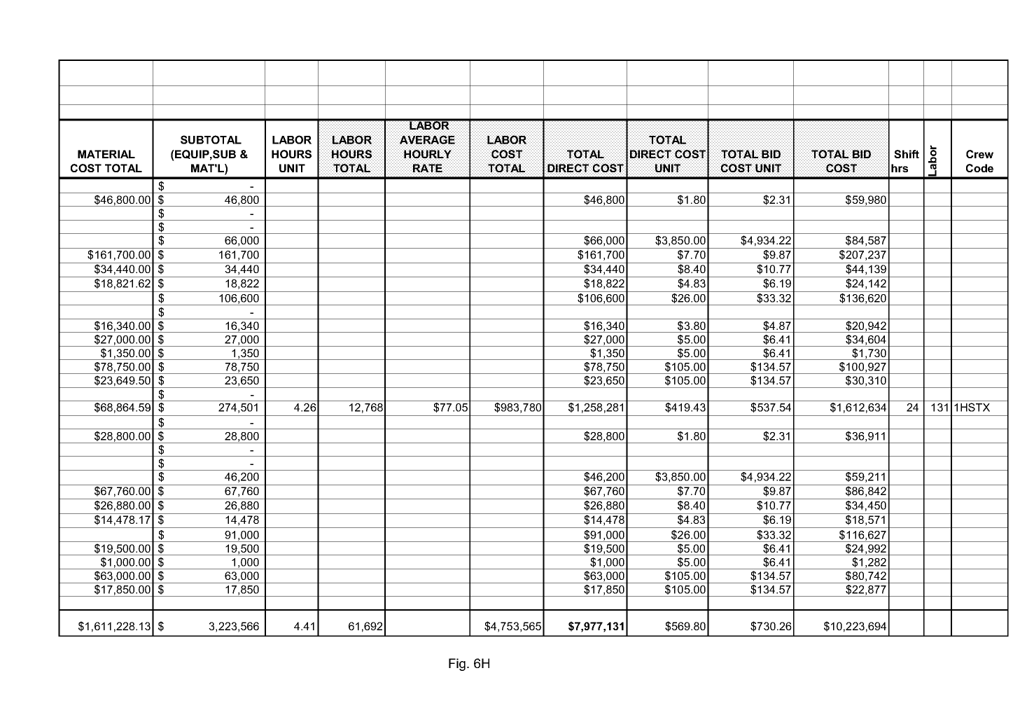

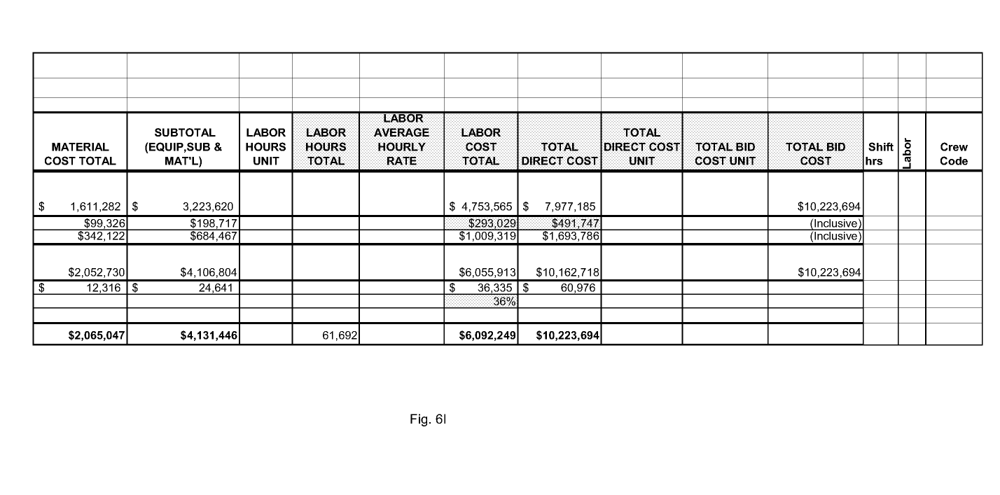

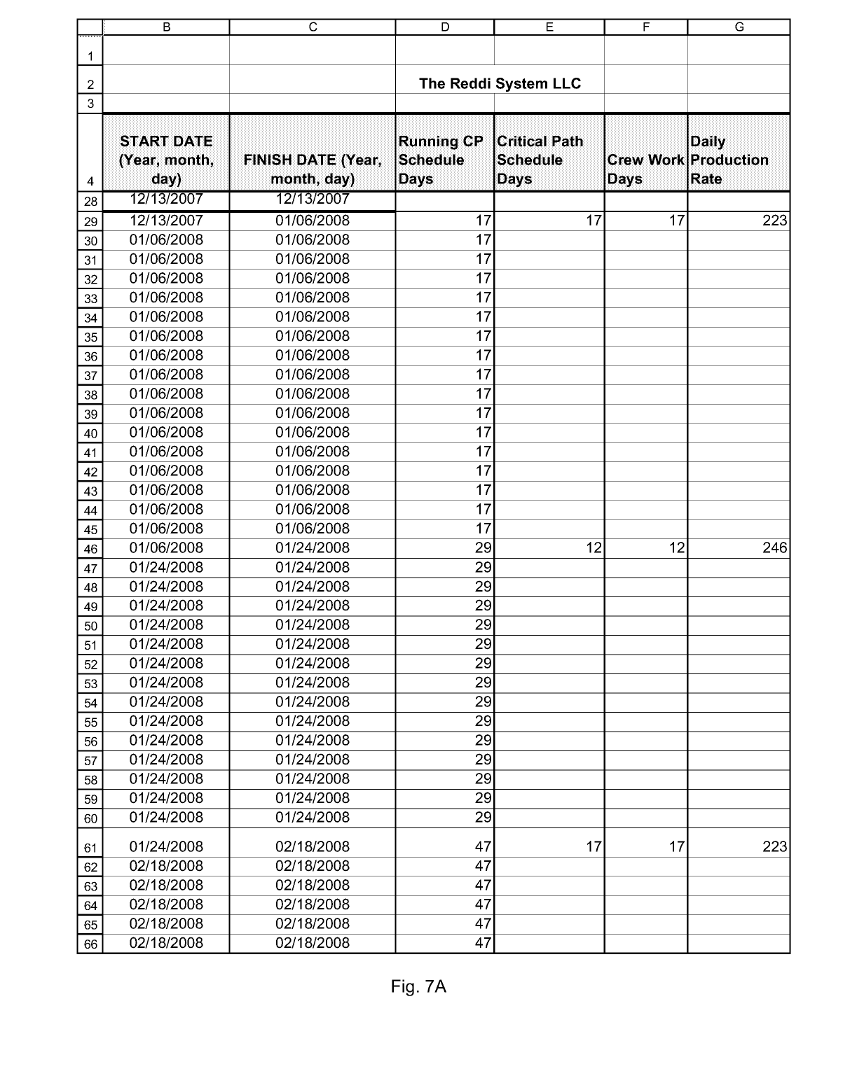

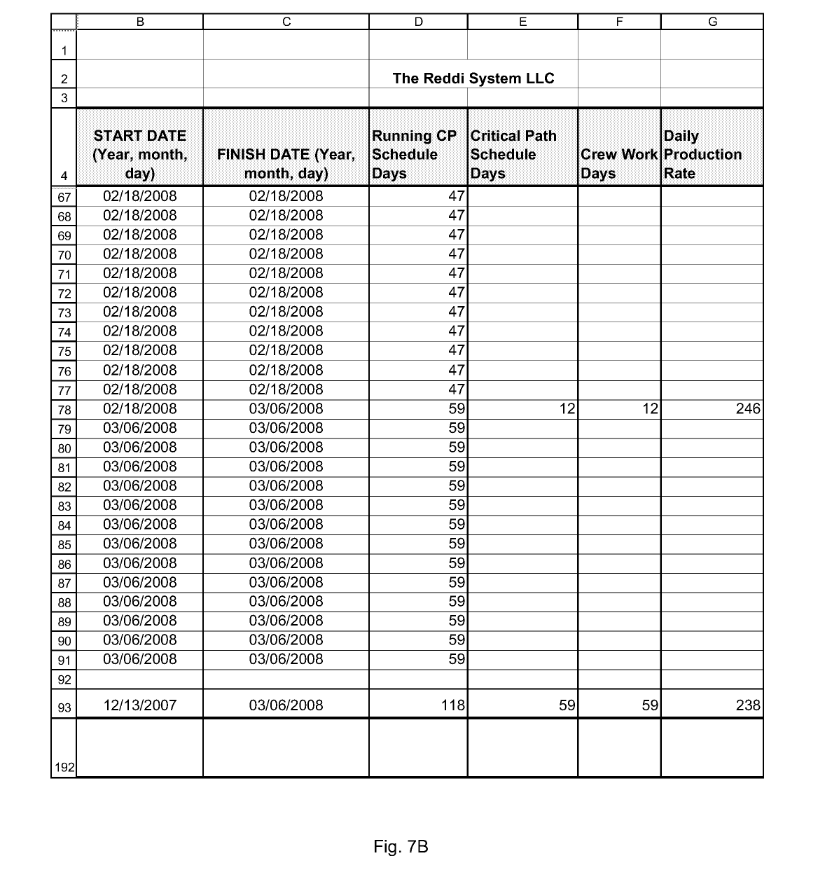

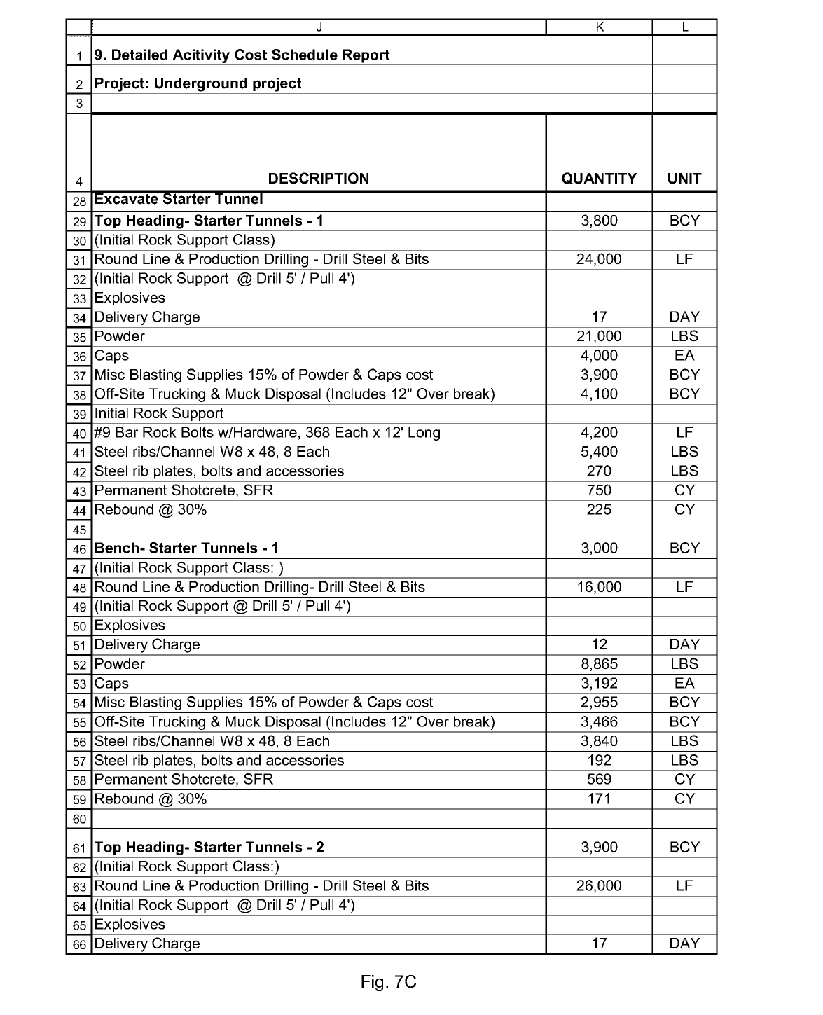

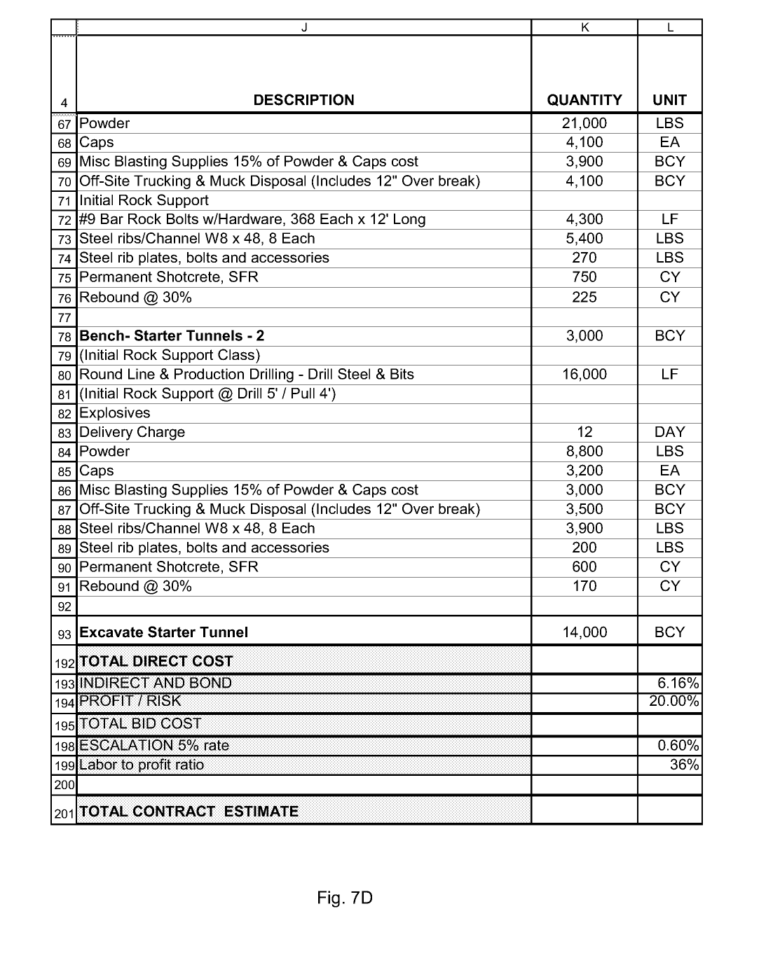

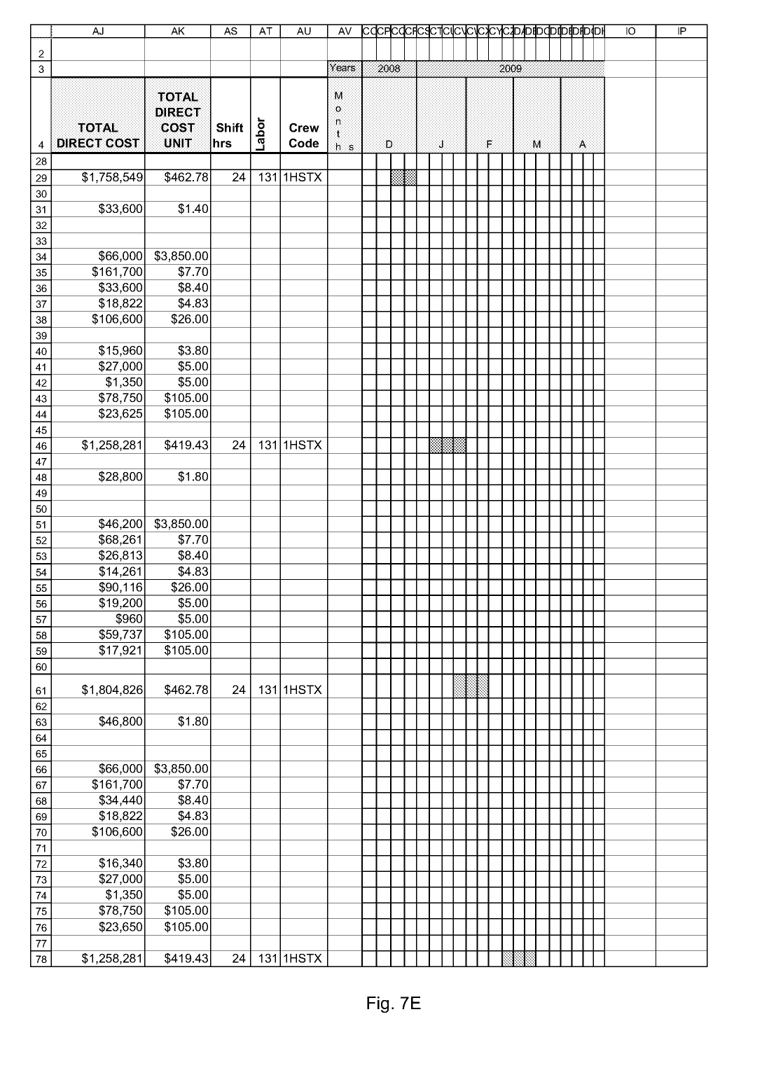

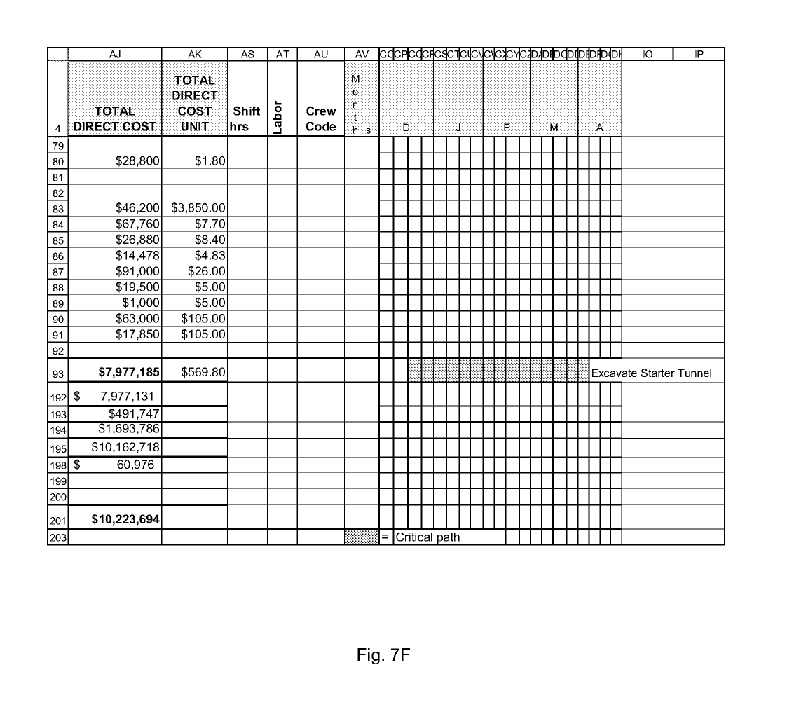

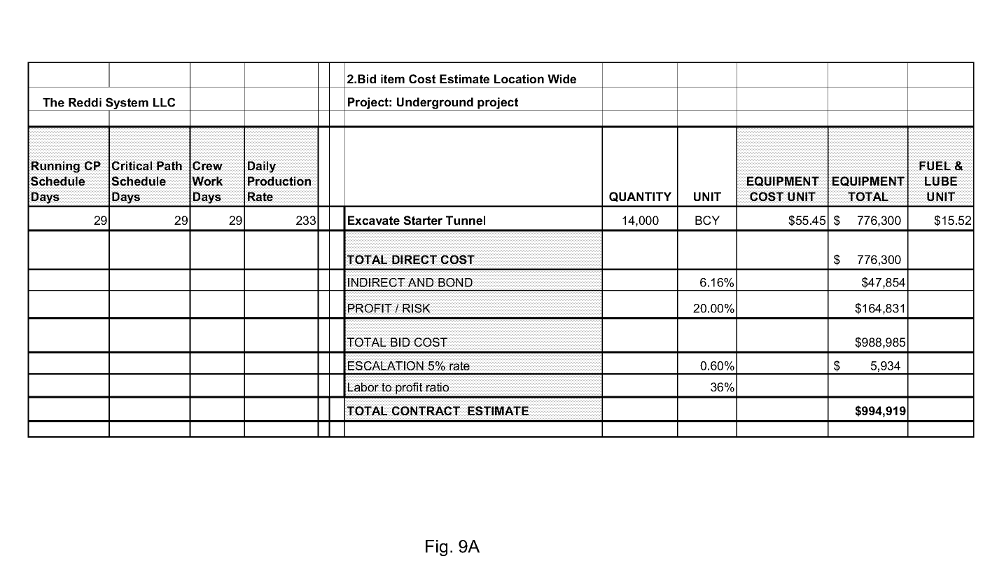

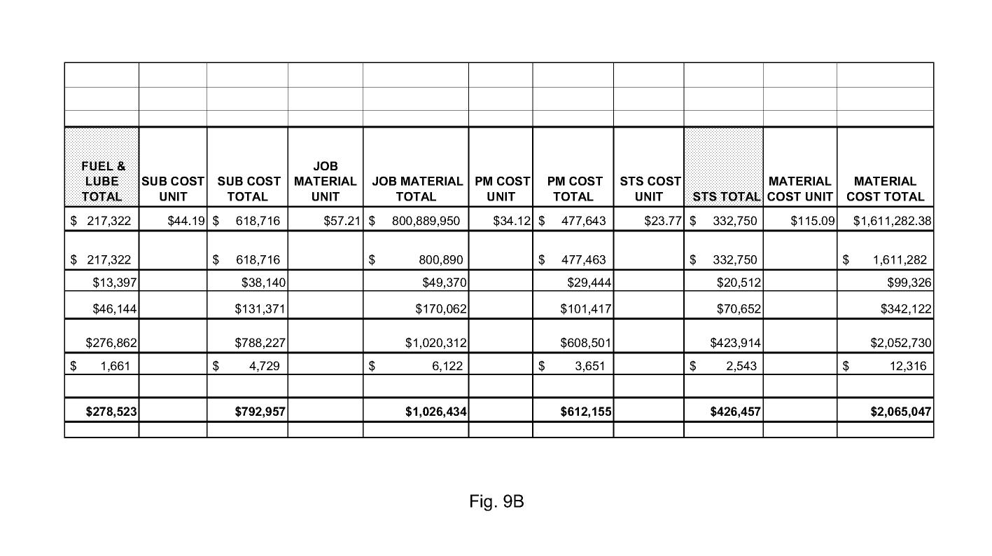

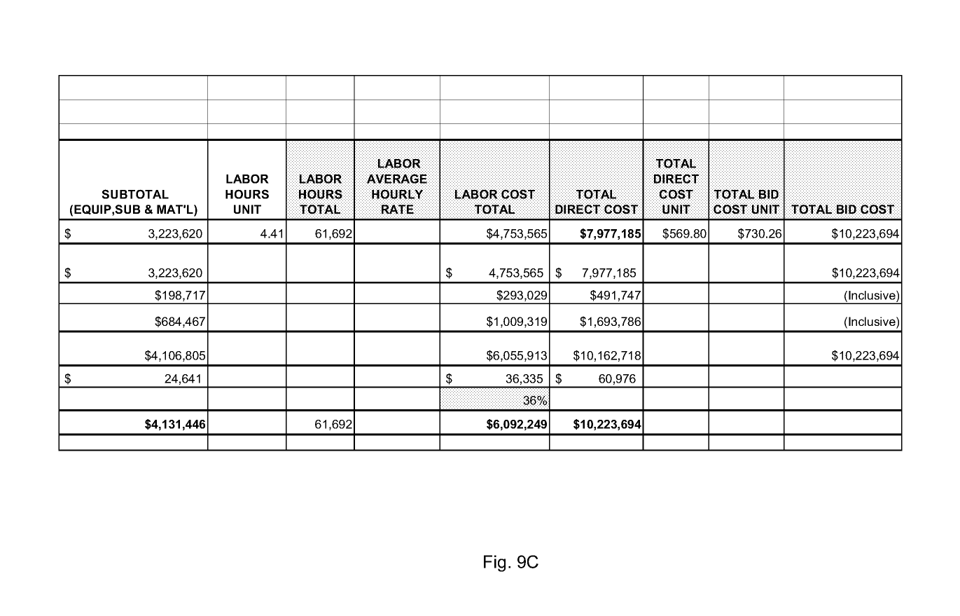

Referring to FIGS. 6A-6I, 7A-7F, 8A-8B and 9A-9V, an estimate and schedule is shown for another project. The project has a number of activities, each of which has days in the critical path of the project. FIGS. 7A-7I indicate the critical path in a bar graph. FIGS. 9A-9C show the total bid cost and the escalated estimated cost (total contract estimate), which is based on the sequence and duration of the activities and project.

Referring to FIG. 6A-6C, the first column “Running CP Schedule Days” contains a running total of the critical path of the project. The second column “Critical Path Schedule Days” contains the amount of critical days to include on said critical path out of the number of days for completion of the activity, for each Activity. The third column “Crew Work Days” contains the number of days for completion of the activity, which is based on the “Daily Production Rate” (column 4) and the “Quantity” (column 6).

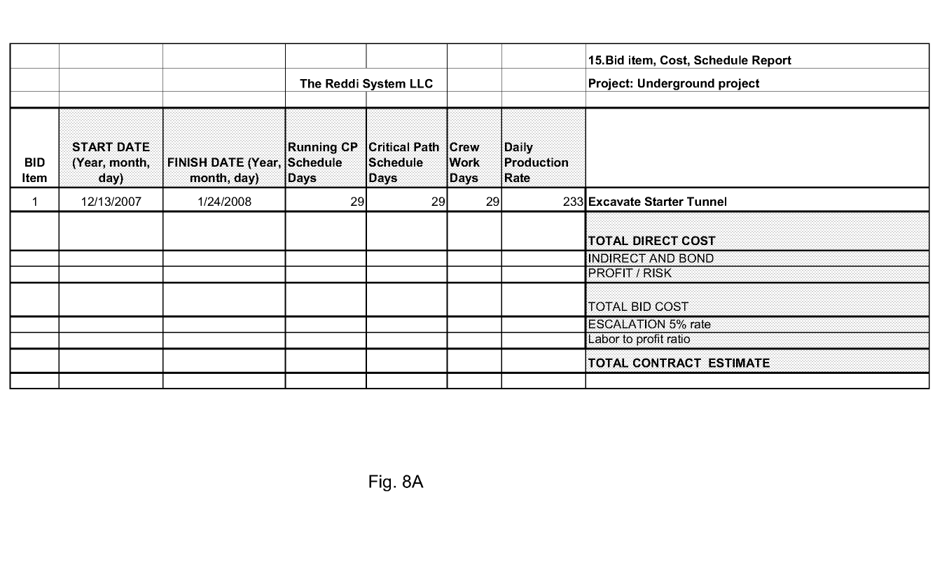

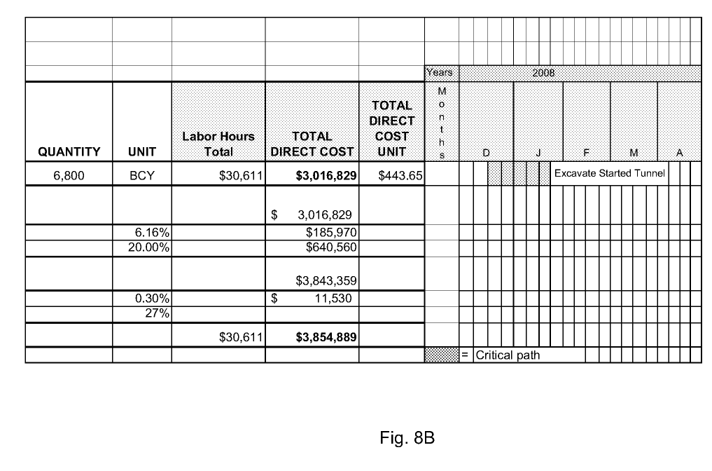

Referring to FIG. 7A-7C, the “Start Date” (column 1) and “Finish Date” (column 2) can be calculated using the “Running CP Schedule Days” and the start date of the project. As can be appreciated, all of he cost items associated with a particular Activity are grouped together because they all share the same start & finish dates. The “Start Date” & “Finish Date” of each Activity is used to plot the project schedule bar graph shown on the left side of FIGS. 7A-8.

### Date Fields

The preferred data fields for data items (some of which may be data entry fields) are as follows:

### Project Main Summary

Project Name

Company Name

Creation Date

User Name

Start Date

Finish Date

### Equipment

Equipment Code

Equipment Description

Picture

Rental Rate

Unit

Fuel, Lube, Parts Cost

Data Import

Labor (about 12-14 different trades)

Labor Code

Labor Description

Base Wages

Holiday Wage

Pension Annuity

Taxable

TLA-Q

TLA-NTQ

TLAQ-T

Wages

Holidays

TAX

Total Taxable

Total

FICA Tax

FUI Tax

SUI Tax

Total Tax

Workers Comp

1.5 Times Overtime

2 Times OT on Base

2 Times On Base

Total Wage Rate

6 Day Daily Rate

6 Day Hourly Rate

Provision

### Permanent Materials

Material Code

Description

Unit

Picture

Cost

### Construction Materials

Material Code

Description

Unit

Picture

Cost

### Small Tools

Material Code

Description

Unit

Picture

% Of Labor Cost

### Material Cost

Material Cost Total

Unit Cost

### Sub-Contract Cost

Code

Description

Unit

Unit Price

### Sub Total

Sub Total

### Activity

Code/SNO

Description

Quantity

Unit

Production

Predecessor

Successor

Duration

Critical Duration

Number Of Shifts

Labor Crew Code

Equipment Crew Code

Hours Per Shift

Start Date

Finish Date

Equipment Cost Unit

Total Equipment Cost

Fuel Lube Unit Cost

Subcontract Unit Cost

Subcontract Total Cost

Perm. Material Cost Unit

Perm. Material Cost Total

Construction Material Unit Cost

Construction Material Cost Total

Small Tools Unit Cost

Small Tools Total Cost

Sub Total Cost Unit

Sub Total

Direct Unit Cost

Total Direct Cost

Total Bid Unit Cost

Total Bid Cost

Quantity Take-Off (Data taken from plans)

Code/SNO

Description

Unit

Activity Quantity

Bill Of Quantity

Calculator

Export To Activity

Group Of Quantity List

Import from CAD Tool

### Business Logic

The formulae used in the calculations are preferably as follows:

| Field Name | Symbol | Description/Formula |
|---|---|---|
| Equipment Cost/Unit | E | Equipment Crew Cost per Day * No. of days per Quantity |
| Fuel&Lube Cost/Unit | F | Fuel Lube Crew Cost per Day * No. of days per Quantity |
| Subcontract Cost/Unit | S | Input, Subcontract Item Cost per Unit |
| Permanent Material | P | Total permanent materials from group list/activity |
| Cost/Unit | | |
| Construction Material | C | Total Construction Material from Group List per Quantity |
| Cost/Unit | | |
| Small Tools Cost/Unit | ST | Sum(Activity Labor Cost) * x %/Quantity |
| Labor Cost/Unit | L | Labor Crew Cost per Unit * No. of days * 8 |
| Total Cost of an Activity | TC | E + F + S + P + C + ST + L |
| Total BID Cost of an | — | TC*(1 + % of indirects) * (1 + % of profit) * (1 + % of escalation) * (1 + |
| Activity | | % of insurance) |
| Total Bid Item Cost | | Total Cost of all activity under each bid items |
| Total each location cost | | Sum of Bid items cost in each location |
| Total Project Cost | | Sum of all locations cost |
| Duration | | |
| Total duration of an | | Total quantity/Daily production |
| activity/Bid Item | | |
| Critical duration of an | | Part or Full duration of an activity |
| activity/Bid Item | | |
| Total critical duration of | | Critical duration from all bid items of each location. |
| each location | | |
| Total critical duration of | | Critical duration from all locations |
| Project | | |
| Escalation Rate for Project | | Annual Rate of Escalation*(Mid Point Date − Base Date)/365 |
| or activity | | |
| Duration to Mid point of | | Base date − ((Finish Date − Start Date)/2 + Start Date)/365 |
| Construction or activity | | |

### Reports

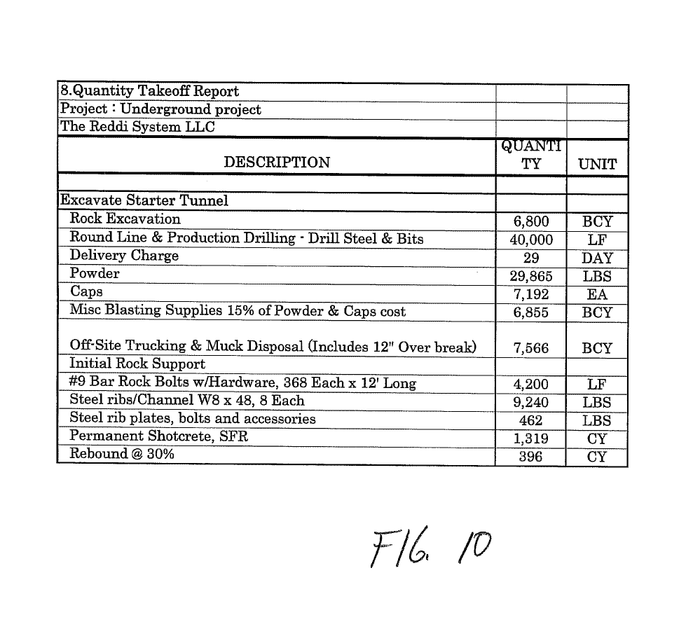

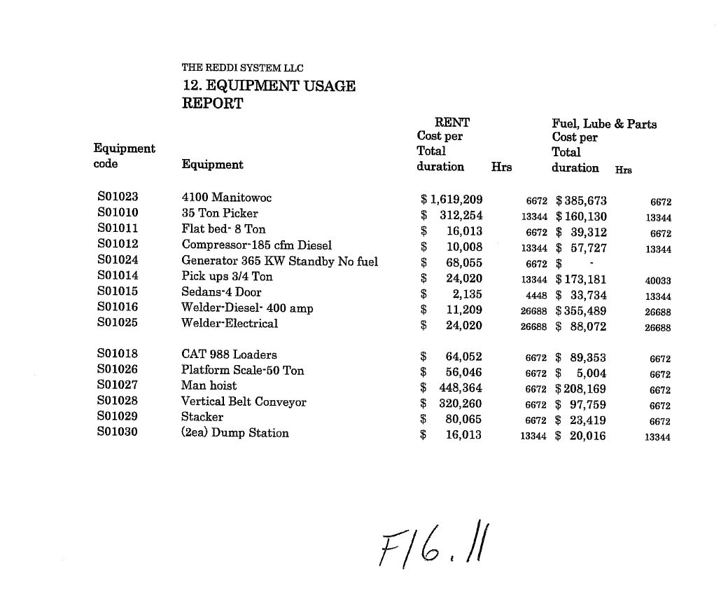

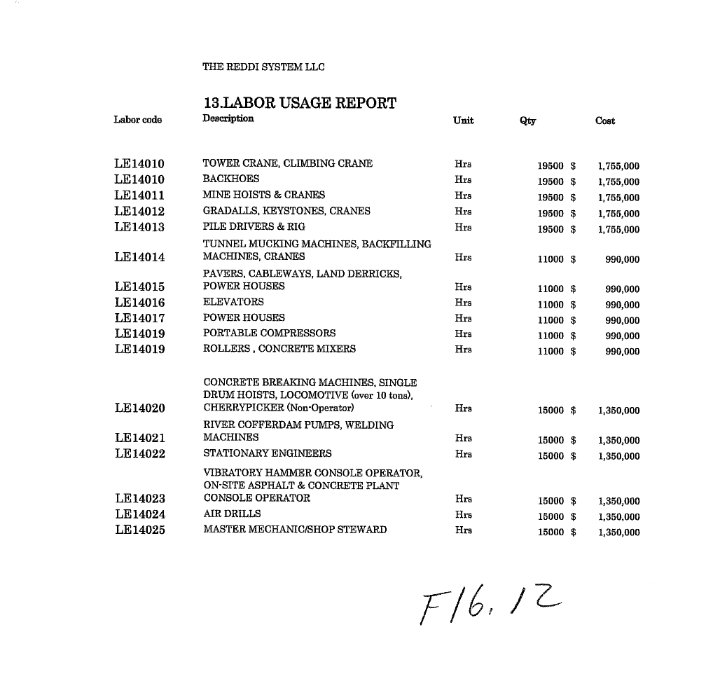

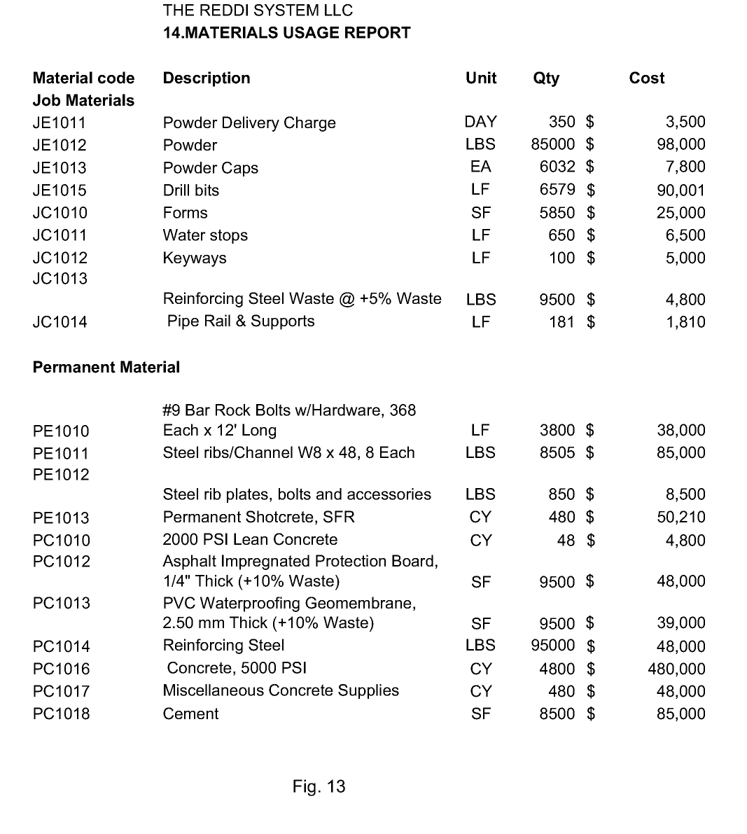

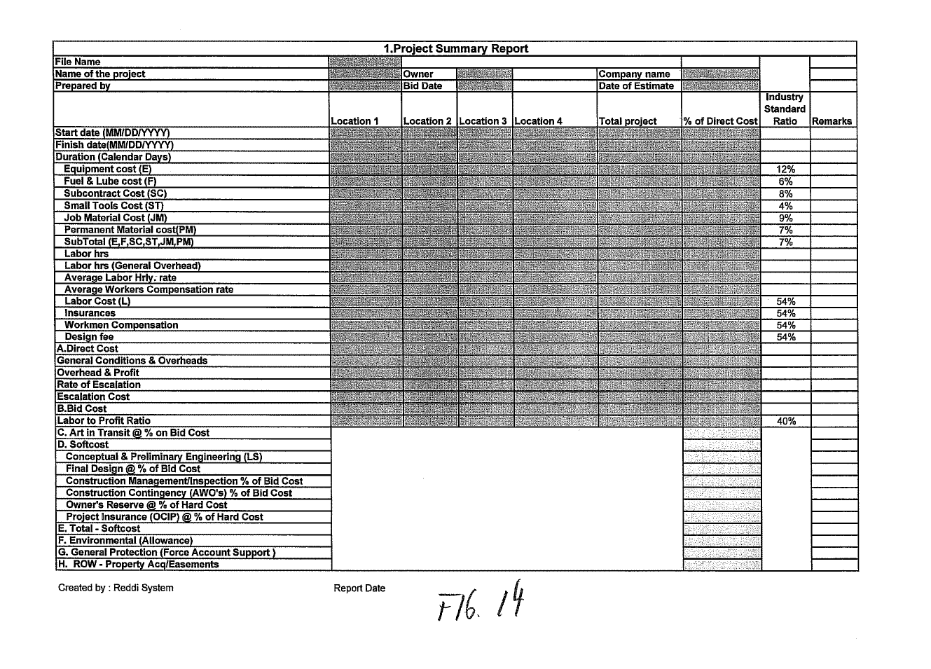

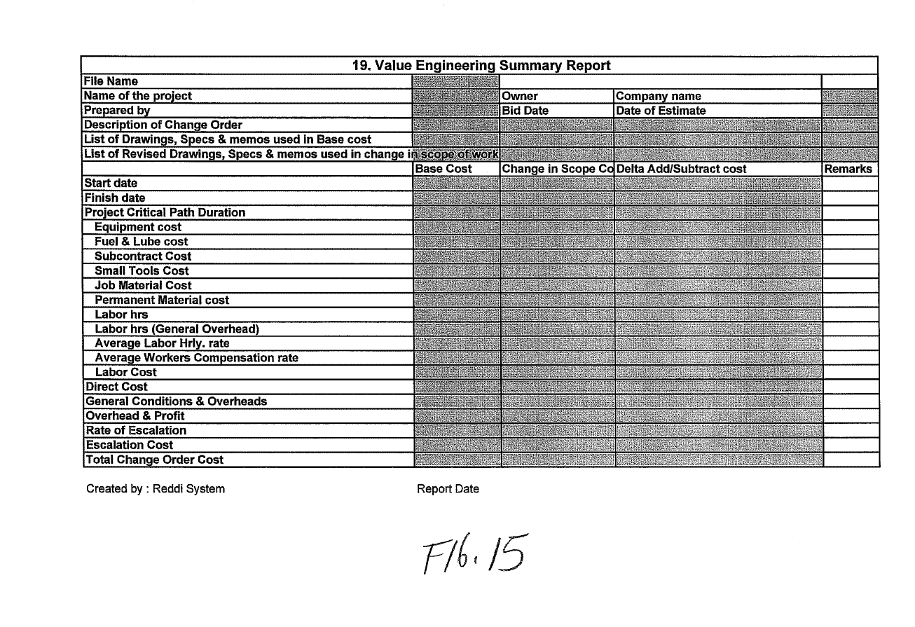

Referring to FIGS. 10-16, the system can preferably generate various predefined and user specified reports, including but not limited to:

Project Summary Report

Bid Items Summary Report

Detailed Cost Estimate Project-wide (several locations)

Detailed Cost Estimate Location-wide

Labor Data Report

Equipment Date Report

Material Data Report

Total Quantity Take-Off Report

Detailed Activity, Cost, Schedule Report

Labor Crew Report

Equipment Crew Report

Labor Usage Report

Material Usage Report

Bid Item, Cost, Schedule Report

Change Order Summary Report

Value Engineering Report

Estimation Qualification Report

Subcontract Date Report

Escalation Calculation Report

### Data Tables

Starting on the next page are various system data tables suitable for a computer system embodying the present invention.

Total Purchase & installation cost
of Instrumentation Instrumentation

| Item | | |
|---|---|---|
| code | Equipment | Price |
| 101010 | Deep Benchmark | $20,000.00 |
| 101011 | Extg Observation Wells (Monitor Only) | $14.00 |
| 101012 | Open Standpipe Pyrometers | $21,606.75 |
| 101013 | Surface Settlement Monitoring Points T1 | $1,200.57 |
| 101014 | Surface monitoring point type 2 | $1,122.76 |
| 101015 | Surface movement monitoring Type 3 | $1,270.00 |
| 101016 | Surface movement monitoring type 4 | $815.00 |
| 101017 | Struct. monitoring point on vertical masonry | $1,058.00 |
| 101018 | Prism for Automated motorized Total Stn. | $789.00 |
| 101019 | Automated Motorized total stations | $35,598.00 |
| 101020 | Tilt meters | $3,995.00 |
| 101021 | Crack Gauges | $661.00 |
| 101022 | 3 point tunnel convergence mntg by extmt | $30.00 |
| 101023 | 3 point tunnel optical survey monitoring | $1,784.55 |
| 101024 | Inclinometer | $51,763.00 |
| 101025 | Vertical MPBK | $21,270.71 |
| 101026 | Horizontal MPBX | $18,422.00 |
| 101027 | Sensor for liquid leveling system | $7,192.00 |
| 101028 | Portable seismographs | $5,400.00 |
| 101029 | High frequency Geophones | $4,030.95 |
| 101030 | Tunnel roof settlement monitoring | $4,148.00 |
| 101031 | Data Loggers | $10,000.00 |
| 101032 | Portable MPBX readout units | $2,640.00 |
| 101033 | Portable inclinometer readout units | $2,640.00 |
| 101034 | Portable tilt meter readout units | $2,640.00 |
| 101036 | Computer stations | $5,000.00 |
| 101037 | Intermediate data storage units | $7,000.00 |
| 101038 | Central data storage unit | $15,000.00 |
| 101039 | Furnish Data Management Software & Equipm | $100,000.00 |
| 101040 | Equipment maintenance | $50,000.00 |
| 101041 | Tunnel Alignment | $750,000.00 |
| 101042 | Installation-Civil Support | $115,000.00 |

10. Labor Crew

| | | | Crew 1 | |
|---|---|---|---|---|
| | MEN | | D | S |
| ITEM | (EA) | DESCRIPTION | Shift | Shift |

GOHM1
NAME: GENERAL OVERHEAD SHAFT 1

| | | | | |
|---|---|---|---|---|
| | | Management & Superintendents | | |
| | 1 | PROJECT MANAGER | 1 | |
| | 1 | ASSISTANT MANAGER | 1 | |
| | 1 | GENERAL SUPERINTENDENT | 1 | |
| | 3 | SHIFT SUPERINTENDENT | 3 | |
| | 1 | TUNNEL SUPERINTENDENT | 1 | |
| | 1 | EQUIPMENT SUPERINTENDENT | 1 | |
| | | Engineering Staff | | |
| | 1 | PROJECT ENGINEER | 1 | |
| | 1 | OFFICE ENGINEER | 1 | |
| | 1 | SCHEDULER ENGINEER | 1 | |
| | 1 | COST ENGINEER | 1 | |
| | 1 | DRAFTSMAN | 1 | |
| | | Quality Assurance Staff | | |
| | 1 | CHIEF QC ENGINEER | 1 | |
| | 2 | ASST. QC ENGINEER | 2 | |
| | | Office Staff | | |
| | 1 | OFFICE MANAGER | 1 | |
| | 1 | SECRETARY | 1 | |
| | 1 | PAYMASTER | 1 | |
| | 1 | TIMEKEEPER | 1 | |
| | | Safety Staff | | |
| | 1 | SAFETY DIRECTOR | 1 | |
| | 2 | ASST. SAFETY DIRECTOR | 2 | |
| | | EMT's | | |
| | 2 | EMT PERSONAL | 2 | |
| | | Shop Mechanics | | |
| | 1 | MASTER MECHANIC LOCAL 14 | 1 | |
| | 3 | MECHANIC/WELDER LOCAL 15C | 3 | |
| | | Shop Stewards | | |
| | 2 | TEAMSTER STEWART LOCAL 282 | 2 | |
| | 2 | TEAMSTER LOCAL 282 | 2 | |
| | | Survey Crew | | |
| | 1 | CHIEF OF PARTY LOCAL 15 D | 1 | |
| | 1 | INSTRUMENT MAN LOCAL 15 D | 1 | |
| | 2 | RODMAN LOCAL 15 D | 2 | |
| TOTAL | 37 | | 37 | — |

CREW: GOH1
NAME: GENERAL OVERHEAD SHAFT 2

| | | | | |
|---|---|---|---|---|
| | | Management & Superintendents | | |
| | 1 | PROJECT MANAGER | 1 | |
| | 1 | ASSISTANT MANAGER | 1 | |
| | 1 | GENERAL SUPERINTENDENT | 1 | |
| | 3 | SHIFT SUPERINTENDENT | 3 | |
| | 1 | EQUIPMENT SUPERINTENDENT | 1 | |
| | | Engineering Staff | | |
| | 1 | PROJECT ENGINEER | 1 | |
| | 1 | OFFICE ENGINEER | 1 | |
| | 1 | SCHEDULER ENGINEER | 1 | |
| | 1 | COST ENGINEER | 1 | |
| | 1 | DRAFTSMAN | 1 | |
| | | Quality Assurance Staff | | |
| | 1 | CHIEF QC ENGINEER | 1 | |
| | 2 | ASST. QC ENGINEER | 2 | |
| | | Office Staff | | |
| | 1 | TIMEKEEPER | 1 | |
| | | Safety Staff | | |
| | 1 | SAFETY DIRECTOR | 1 | |
| | 2 | ASST. SAFETY DIRECTOR | 2 | |
| | | EMT's | | |
| | 3 | EMT PERSONAL | 3 | |
| | | Shop Mechanics | | |
| | 1 | MASTER MECHANIC LOCAL 14 | 1 | |
| | 3 | MECHANIC/WELDER LOCAL 15C | 3 | |
| | | Shop Stewarts | | |
| | 2 | TEAMSTER STEWART LOCAL 282 | 2 | |
| | 2 | TEAMSTER LOCAL 282 | 2 | |
| | | Survey Crew | | |
| | 1 | CHIEF OF PARTY LOCAL 15 D | 1 | |
| | 1 | INSTRUMENT MAN LOCAL 15 D | 1 | |
| | 2 | RODMAN LOCAL 15 D | 2 | |
| TOTAL | 34 | | 34 | — |

CREW: PUMP
NAME: PUMP OPERATOR

| | | | | |
|---|---|---|---|---|
| | 3 | PUMP MAN LOCAL 15 | 1 | 1 |
| TOTAL | 3 | — | 1 | 1 |

CREW: YAOS
NAME: YARD (USE DURING CONCRETE WORK)

| | | | | |
|---|---|---|---|---|
| | 1 | SUPERINTENDANT ENGINEER | 1 | |
| | 1 | ENGINEER | 1 | |
| | 1 | PICKER OPERATOR-45 TON LOCAL 14 | 1 | |
| | 1 | PICKER OPERATOR-45 TON LOCAL 15 | 1 | |
| | 1 | PICKER OPERATOR LOCAL 15 | 1 | |
| | 1 | RIGGER FOREMAN LOCAL 147 | 1 | |
| | 1 | RIGGERS LOCAL 147 | 1 | |
| | 2 | MECHANIC- LOCAL 15C | 2 | |
| | 1 | FOREMAN REBAR LATHER LOCAL 46 | 1 | |
| | 5 | LATHERS-BENDING REBAR | 5 | |
| | 6 | LATHERS-REBAR FEED STACKING | 6 | |
| | 1 | ELECTRICIAN LOCAL 3 | 1 | |
| | 3 | TEAMSTERS | 3 | |
| TOTAL | 25 | | 25 | — |

CREW: MOB12
NAME: MOBILIZATION-Site 1

| | | | | |
|---|---|---|---|---|
| | 1 | 4100 CRANE OPERATOR LOCAL 14 | 1 | |
| | 1 | 4100 CRANE OILER LOCAL 15 | 1 | |
| | 1 | COMPRESSOR OPERATOR LOCAL 14 | 1 | |
| | 1 | GENERAL OILER LOCAL 15 | 1 | |
| | 1 | LOADER OPERATOR LOCAL 15 | 1 | |
| | 2 | CHERRY PICKER OPERATOR- 35 TON. LOCAL 15 | 2 | |
| | 4 | MECHANIC- LOCAL 15C | 4 | |
| | 1 | CHANGEHOUSE MAN LOCAL 147 | 1 | |
| | 1 | RIGGER FOREMAN LOCAL 147 | 1 | |
| | 4 | RIGGERS LOCAL 147 | 4 | |
| | 1 | LABOR FOREMAN LOCAL 731 | 1 | |
| | 4 | LABOR LOCAL 731 | 4 | |
| | 1 | WAREHOUSE LOCAL 282 | 1 | |
| | 1 | CARPENTER FOREMAN | 1 | |
| | 6 | CARPENTER | 6 | |
| | 1 | BACKHOE OPERATOR LOCAL 14 | 1 | |
| | 1 | BACKHOE OILER LOCAL 15 | 1 | |
| | 1 | TEAMSTERS | 1 | |
| | 1 | ELECTRICAL FOREMAN LOCAL 3 | 1 | |
| | 8 | ELECTRICIAN LOCAL 3 | 8 | |
| TOTAL | 42 | | 42 | — |

CREW: IMON
NAME: INSTRUMENT MONITORING

| | 1 | CHIEF OF PARTY LOCAL 15 D | 1 | |
|---|---|---|---|---|
| | 1 | INSTRUMENT MAN LOCAL 15 D | 1 | |
| | 2 | RODMAN LOCAL 15 D | 2 | |
| TOTAL | 4 | | 4 | — |
| | | | SHIFT [symbol] | |
| | MEN | | STRAIGHT TIME | |
| ITEM | (EA) | DESCRIPTION | PER MAN | TOTAL |

CREW SHEE [symbol]
CREW: 1SCGW
NAME: Secant Piles - Form, Restee & Concrete Guide Wall

| | | LABOR | | |
|---|---|---|---|---|
| | 1 | CARPENTER FOREMAN | 8 | 8 |
| | 4 | CARPENTERS | 8 | 32 |
| | 1 | LATHER FOREMAN | 8 | 8 |
| | 3 | LATHERS | 8 | 24 |
| | 2 | LABORERS | 8 | 16 |
| TOTAL | 11 | | | |
| | EQUIP. | | | |
| ITEM | (EA) | DESCRIPTION | | |
| | | EQUIPMENT | | |
| TOTAL | 0 | | | |
| | 1 | SMALL TOOLS (7%) | | |
| TOTAL | 1 | | | |
| | | | Crew 1 | |
| | MEN | | D | S |
| ITEM | (EA) | DESCRIPTION | Shift | Shift |
| | 3 | BACKHOE OILER LOCAL 15 | 1 | 1 |
| TOTAL | 3 | | 1 | 1 |

CREW: 1HAX
NAME: D&B EXCAVATION FOR ADIT 1

| | | | | |
|---|---|---|---|---|
| | | LABOR | | |
| | 3 | WALKING BOSS LOCAL 147 | 1 | 1 |
| | 3 | HEADING FOREMAN LOCAL 147 | 1 | 1 |
| | 18 | MINER LOCAL 147 | 6 | 6 |
| | 18 | MINER CHUCKTENDERS LOCAL 29 | 6 | 6 |
| | 6 | ELECTRICIAN LOCAL 147 | 2 | 2 |
| | 3 | MUCKER OPERATOR LOCAL 15 | 1 | 1 |
| | 3 | MECHANICS LOCAL 15 C | 1 | 1 |
| | 3 | SAFETY MINER LOCAL 147 | 1 | 1 |
| | 3 | POWDER CARRIER/BLASTER LOCAL 29 | 1 | 1 |
| TOTAL | 60 | | 20 | 20 |

CREW: 1HSTX
NAME: D&B EXCAVATION FOR STARTER & TAIL TUNNEL

| | | | | |
|---|---|---|---|---|
| | | LABOR | | |
| | 6 | WALKING BOSS LOCAL 147 | 1 | 1 |
| | 6 | HEADING FOREMAN LOCAL 147 | 1 | 1 |
| | 42 | MINER LOCAL 147 | 7 | 7 |
| | 42 | MINER CHUCKTENDERS LOCAL 29 | 7 | 7 |
| | 6 | ELECTRICIAN LOCAL 147 | 1 | 1 |
| | 6 | MAINTENANCE MAN/OPERA LOCAL 15 | 1 | 1 |
| | 6 | MUCKER OPERATOR LOCAL 15 | 1 | 1 |
| | 3 | SAFETY MINER LOCAL 147 | 1 | 1 |
| | 6 | POWDER CARRIER/BLASTER LOCAL 29 | 1 | 1 |
| | 6 | DRILL JUMBO OPERATOR LOCAL 15 | 1 | 1 |
| | 2 | SHOTCRETE OPERATOR LOCAL | | |
| TOTAL | 131 | | 22 | 22 |

CREW: 1SSIX
NAME: SERVICE CREW-SOUTH INTERLOCKING & CROSS PASSAGE EX

| | | | | |
|---|---|---|---|---|
| | 1 | 4100 CRANE OPERATOR LOCAL 14 | 1 | 0 |
| | 1 | 4100 CRANE OILER LOCAL 15 | 1 | 0 |
| | 3 | MINE HOIST OPERATOR LOCAL 14 | 1 | 1 |
| | 3 | MINE HOIST OILER LOCAL 15 | 1 | 1 |
| | 3 | MECHANIC FOREMAN LOCAL 15 C | 1 | 1 |
| | 8 | MECHANICS LOCAL 15 C | 4 | 2 |
| | 3 | COMPRESSOR OPERATOR LOCAL15 | 1 | 1 |
| | 3 | PUMPMAN LOCAL 15 | 1 | 1 |
| | 1 | LOADER OPERATOR LOCAL 15 | 1 | 0 |
| | 1 | PICKER OPERATOR LOCAL 15 | 1 | 0 |
| | 7 | TOP BELL LOCAL 147 | 3 | 2 |
| | 3 | BOTTOM BELL LOCAL 147 | 1 | 1 |
| | 2 | POWDER WATCHMAN LOCAL 147 | 1 | 1 |
| | 3 | CHANGEHOUSE MAN LOCAL 147 | 1 | 1 |
| | 1 | LABOR FOREMAN LOCAL 731 | 1 | 0 |
| | 4 | LABOR LOCAL 731 | 2 | 1 |
| | 3 | SHIFT ENGINEER LOCAL 15D | 1 | 1 |
| | 1 | WAREHOUSE LOCAL 282 | 1 | 0 |
| | 2 | POWDER WATCHMAN LOCAL 147 | 1 | 1 |
| TOTAL | 53 | | 25 | 15 |

CREW: 1HSIX
NAME: D&B EXCAVATION FOR 34TH STREET STATION SOUTH INTERL

[symbol]

| | | | | |
|---|---|---|---|---|
| | 4 | WALKING BOSS LOCAL 147 | 2 | 1 |
| | 3 | HEADING FOREMAN LOCAL 147 | 1 | 1 |
| | 30 | MINER LOCAL 147 | 10 | 10 |
| | 3 | SAFETY MINER LOCAL 147 | 1 | 1 |
| | 3 | MOTORMAN LOCAL 147 | 1 | 1 |
| | 3 | BRAKEMAN LOCAL 147 | 1 | 1 |
| | 3 | MAINTENANCE MAN/OPERA LOCAL 15 | 1 | 1 |
| | 0 | BULLGANG FOREMAN LOCAL 147 | | |
| | 0 | BULLGANG MINER LOCAL 147 | | |
| | 6 | ELECTRICIAN LOCAL 147 | 2 | 2 |
| | 2 | POWDER CARRIER/BLASTER LOCAL 29 | 1 | 1 |
| | 1 | SHOTCRETE OPERATOR LOCAL | 0 | 0 |
| | 1 | SHOTCRETE MINER LOCAL | 0 | 0 |
| | 1 | DRILL JUMBO OPERATOR LOCAL 15 | 1 | |
| TOTAL | 60 | | 21 | 19 |

CREW: 1HCPX
NAME: D&B EXCAVATION FOR CROSS PASSAGE

| | | | | |
|---|---|---|---|---|
| | | LABOR | | |
| | 4 | WALKING BOSS LOCAL 147 | 2 | 1 |
| | 3 | HEADING FOREMAN LOCAL 147 | 1 | 1 |
| | 18 | MINER LOCAL 147 | 6 | 6 |
| | 6 | ELECTRICIAN LOCAL 147 | 2 | 2 |
| | 6 | MAINTENANCE MAN/OPERA LOCAL 15 | 2 | 2 |
| | 3 | SAFETY MINER LOCAL 147 | 1 | 1 |
| | 2 | MUCKER OPERATOR LOCAL 15 | 1 | 1 |
| | 2 | DRILL JUMBO OPERATOR LOCAL 15 | 1 | 1 |
| | 2 | POWDER CARRIER/BLASTER LOCAL 29 | 1 | 1 |
| | 1 | SHOTCRETE OPERATOR LOCAL | 0 | 0 |
| | 1 | SHOTCRETE MINER LOCAL | 0 | 0 |
| TOTAL | 48 | | 17 | 16 |

CREW: 1STBMA
NAME: SERVICE CREW-TBM ASSEMBLY CREW SITE 1

| | | | | |
|---|---|---|---|---|
| | | LABOR | | |
| | 2 | 4100 CRANE OPERATOR LOCAL 14 | 1 | 1 |
| | 2 | 4100 CRANE OILER LOCAL 15 | 1 | 1 |
| | 2 | MINE HOIST OPERATOR LOCAL 14 | 1 | 1 |
| | 2 | MECHANIC FOREMAN LOCAL 15 C | 1 | 1 |
| | 8 | MECHANICS LOCAL 15 C | 4 | 4 |
| | 2 | COMPRESSOR OPERATOR LOCAL15 | 1 | 1 |
| | 2 | PICKER OPERATOR LOCAL 15 | 1 | 1 |
| | 2 | PICKER OPERATOR OILER LOCAL 15 | 1 | 1 |
| | 2 | PUMPMAN LOCAL 15 | 1 | 1 |
| | 5 | TOP BELL LOCAL 147 | 3 | 2 |
| | 4 | BOTTOM BELL LOCAL 147 | 2 | 2 |
| | 2 | RIGGER FOREMAN LOCAL 147 | 1 | 1 |
| | 4 | RIGGERS LOCAL 147 | 2 | 2 |
| | 2 | CHANGEHOUSE MAN LOCAL 147 | 1 | 1 |
| | 1 | LABOR FOREMAN LOCAL 731 | 1 | 0 |
| | 3 | LABOR LOCAL 731 | 2 | 1 |
| | 1 | SHIFT ENGINEER LOCAL 15D | 1 | |
| | 1 | WAREHOUSE LOCAL 282 | 1 | 0 |
| TOTAL | 47 | | 26 | 21 |

CREW: 1HTBM1
NAME: TBM ASSEMBLY CREW

| | | | | |
|---|---|---|---|---|
| | 3 | WALKING BOSS LOCAL 147 | 2 | 1 |
| | 2 | HEADING FOREMAN LOCAL 147 | 1 | 1 |
| | 8 | MINER LOCAL 147 | 4 | 4 |
| | 2 | SAFETY MINER LOCAL 147 | 1 | 1 |
| | 2 | RIGGER FOREMAN LOCAL 147 | 1 | 1 |
| | 4 | RIGGERS LOCAL 147 | 2 | 2 |
| | 4 | ELECTRICIAN LOCAL 147 | 2 | 2 |
| | 8 | MAINTENANCE MAN/OPERA LOCAL 15 | 4 | 4 |
| | 2 | TBM OPERATOR LOCAL 14 | 1 | 1 |
| | 2 | TBM OILER LOCAL 15 | 1 | 1 |
| | 2 | GANTRY CRANE OPERATOR | 1 | 1 |
| TOTAL | 39 | | 20 | 19 |

CREW: 1STBMX
NAME: SERVICE CREW-TBM EXCAVATION-SITE 1

| | | | | |
|---|---|---|---|---|
| | | LABOR | | |
| | 3 | 4100 CRANE OPERATOR LOCAL 14 | 1 | 1 |
| | 3 | 4100 CRANE OILER LOCAL 15 | 1 | 1 |
| | 3 | MINE HOIST OPERATOR LOCAL 14 | 1 | 1 |
| | 3 | MINE HOIST OILER LOCAL 15 | 1 | 1 |
| | 3 | COMPRESSOR OPERATOR LOCAL15 | 1 | 1 |
| | 1 | GENERAL OILER LOCAL 15 | 1 | 0 |
| | 3 | PUMPMAN LOCAL 15 | 1 | 1 |
| | 3 | LOADER OPERATOR LOCAL 15 | 1 | 1 |
| | 1 | PICKER OPERATOR LOCAL 15 | 1 | 0 |
| | 3 | MECHANIC FOREMAN LOCAL 15 C | 1 | 1 |
| | 8 | MECHANICS LOCAL 15 C | 4 | 2 |
| | 3 | MECHANIC STACKER CONVEYOR LOCAL 15 C | 1 | 1 |
| | 6 | MECHANIC DUMP #1, #2 CONVEYOR LOCAL 15 C | 2 | 2 |
| | 3 | MECHANIC VERTICAL CONVEYOR LOCAL 15 C | 1 | 1 |
| | 6 | CHANGEHOUSE MAN LOCAL 147 | 2 | 2 |
| | 7 | TOP BELL LOCAL 147 | 3 | 2 |
| | 6 | BOTTOM BELL LOCAL 147 | 2 | 2 |
| | 1 | LABOR FOREMAN LOCAL 731 | 1 | 0 |
| | 8 | LABOR LOCAL 731 | 4 | 2 |
| | 6 | HEADING ENGINEER | 2 | 2 |
| | 1 | ELECTRICAL FOREMAN LOCAL 3 | 1 | |
| | 3 | ELECTRICIAN LOCAL 3 | 1 | 1 |
| | 2 | WAREHOUSE LOCAL 282 | 1 | 1 |
| TOTAL | 86 | | 35 | 26 |

CREW: 1HTBMX
NAME: TBM EXCAVATION

| | | | | |
|---|---|---|---|---|
| | | LABOR | | |
| | 8 | WALKING BOSS LOCAL 147 | 2 | 1 |
| | 6 | HEADING FOREMAN LOCAL 147 | 1 | 1 |
| | 12 | MINER LOCAL 147 | 2 | 2 |
| | 6 | MINER ERECTOR SEGMENTS LOCAL 147 | 1 | 1 |
| | 12 | MINER- SEGMENTS LOCAL 147 | 2 | 2 |
| | 2 | BULLGANG FOREMAN LOCAL 147 | 1 | |
| | 8 | BULLGANG MINER LOCAL 147 | 4 | |
| | 6 | GROUT FOREMAN LOCAL 147 | 1 | 1 |
| | 24 | MINER- GROUT LOCAL 147 | 4 | 4 |
| | 6 | PEA GRAVEL OPERATOR LOCAL 15 | 1 | 1 |
| | 6 | SAFETY MINER LOCAL 147 | 1 | 1 |
| | 18 | LOCOMOTIVE OPERATOR LOCAL 14 | 3 | 3 |
| | 18 | BRAKEMAN LOCAL 147 | 3 | 3 |
| | 12 | MECHANIC- LOCAL 15C | 2 | 2 |
| | 12 | ELECTRICIAN LOCAL 147 | 2 | 2 |
| TOTAL | 156 | | 30 | 24 |

CREW: 1SASTC
NAME: SERVICE CREW- STARTER, TAIL, ADIT CONCRETE- SITE 1

| | | | | |
|---|---|---|---|---|
| | | LABOR | | |
| | 1 | 4100 CRANE OPERATOR LOCAL 14 | 1 | |
| | 1 | 4100 CRANE OILER LOCAL 15 | 1 | |
| | 3 | MINE HOIST OPERATOR LOCAL 14 | 1 | 1 |
| | 3 | MINE HOIST OILER LOCAL 15 | 1 | 1 |
| | 3 | MECHANIC FOREMAN LOCAL 15 C | 1 | 1 |
| | 6 | MECHANICS LOCAL 15 C | 2 | 2 |
| | 3 | COMPRESSOR OPERATOR LOCAL 15 | 1 | 1 |
| | 3 | PUMPMAN LOCAL 15 | 1 | 1 |
| | 1 | PICKER OPERATOR LOCAL 15 | 1 | |
| | 1 | RIGGER FOREMAN LOCAL 147 | 1 | |
| | 2 | RIGGERS LOCAL 147 | 2 | |
| | 7 | TOP BELL LOCAL 147 | 3 | 2 |
| | 6 | BOTTOM BELL LOCAL 147 | 2 | 2 |
| | 3 | CHANGEHOUSE MAN LOCAL 147 | 1 | 1 |
| | 1 | LABOR FOREMAN LOCAL 731 | 1 | 0 |
| | 4 | LABOR LOCAL 731 | 2 | 1 |
| | 1 | WAREHOUSE LOCAL 282 | 1 | 0 |
| | 3 | SHIFT ENGINEER LOCAL 15D | 1 | 1 |
| TOTAL | 52 | | 24 | 14 |

CREW: 1HASTC
NAME: CONCRETE -ADIT, STARTER & TAIL TUNNEL- SITE 1

| | | | | |
|---|---|---|---|---|
| | | LABOR | | |
| | 4 | WALKING BOSS LOCAL 147 | 2 | 1 |
| | 3 | CONCRETE HEADING FOREMAN LOCAL 147 | 1 | 1 |
| | 26 | MINER-FORM CREW LOCAL 147 | 10 | 8 |
| | 3 | SAFETY MINER LOCAL 147 | 1 | 1 |
| | 6 | MAINTENANCE MAN/OPERA LOCAL 15 | 2 | 2 |
| | 6 | ELECTRICIAN LOCAL 147 | 2 | 2 |
| | 2 | FORM CARRIER OPERATOR | 1 | 1 |
| | 2 | CONCRETE PUMP OPERATOR LOCAL 14 | 1 | 1 |
| | 2 | CONCRETE PUMP OILER | 1 | 1 |
| TOTAL | 54 | | 21 | 18 |

CREW: 1SSIC
NAME: SERVICE CONCRETE -SOUTH INTERLOCKING

| | | | | |
|---|---|---|---|---|
| | | LABOR | | |
| | 3 | MINE HOIST OPERATOR LOCAL 14 | 1 | 1 |
| | 3 | MINE HOIST OILER LOCAL 15 | 1 | 1 |
| | 3 | COMPRESSOR OPERATOR LOCAL 15 | 1 | 1 |
| | 3 | PUMPMAN LOCAL 15 | 1 | 1 |
| | 3 | MECHANIC FOREMAN LOCAL 15 C | 1 | 1 |
| | 4 | MECHANICS LOCAL 15 C | 2 | 1 |
| | 2 | PICKER OPERATOR LOCAL 15 | 1 | 1 |
| | 2 | RIGGER FOREMAN LOCAL 147 | 1 | 1 |
| | 4 | RIGGERS LOCAL 147 | 2 | 2 |
| | 9 | TOP BELL LOCAL 147 | 3 | 3 |
| | 6 | BOTTOM BELL LOCAL 147 | 2 | 2 |
| | 3 | CHANGEHOUSE MAN LOCAL 147 | 1 | 1 |
| | 1 | LABOR FOREMAN LOCAL 731 | 1 | 0 |
| | 8 | LABOR LOCAL 731 | 4 | 2 |
| | 1 | WAREHOUSE LOCAL 282 | 1 | 0 |
| | 3 | SHIFT ENGINEER LOCAL 15D | 1 | 1 |
| TOTAL | 58 | | 24 | 19 |

CREW: 1HSIC
NAME: CONCRETE -SOUTH INTERLOCKING

| | | | | |
|---|---|---|---|---|
| | | LABOR | | |
| | 4 | WALKING BOSS LOCAL 147 | 2 | 1 |
| | 3 | CONCRETE HEADING FOREMAN LOCAL 147 | 1 | 1 |
| | 24 | MINER-FORM CREW LOCAL 147 | 8 | 8 |
| | 3 | SAFETY MINER LOCAL 147 | 1 | 1 |
| | 3 | MOTOR MAN LOCAL 14 | 1 | 1 |
| | 3 | BRAKEMAN LOCAL 147 | 1 | 1 |
| | 6 | MAINTENANCE MAN/OPERA LOCAL 15 | 2 | 2 |
| | 6 | ELECTRICIAN LOCAL 147 | 2 | 2 |
| | 0 | BULLGANG FOREMAN LOCAL 147 | | |
| | 0 | BULLGANG MINER LOCAL 147 | | |
| | 2 | CONCRETE PUMP OPERATOR LOCAL 14 | 1 | 1 |
| | 2 | CONCRETE PUMP OILER | 1 | 1 |
| | 2 | FORM CARRIER OPERATOR | 1 | 1 |
| TOTAL | 58 | | 21 | 20 |

CREW: 1HCPC
NAME: CONCRETE -CROSS PASSAGES

| | | | | |
|---|---|---|---|---|
| | | LABOR | | |
| | 3 | WALKING BOSS LOCAL 147 | 1 | 1 |
| | 3 | CONCRETE HEADING FOREMAN LOCAL 147 | 1 | 1 |
| | 24 | MINER-FORM CREW LOCAL 147 | 8 | 8 |
| | 3 | SAFETY MINER LOCAL 147 | 1 | 1 |
| | 6 | MOTOR MAN LOCAL 14 | 2 | 2 |
| | 3 | BRAKEMAN LOCAL 147 | 1 | 1 |
| | 3 | MAINTENANCE MAN/OPERA LOCAL 15 | 1 | 1 |
| | 6 | ELECTRICIAN LOCAL 147 | 2 | 2 |
| | 1 | FORM CARRIER OPERATOR | 1 | 0 |
| | 1 | CONCRETE PUMP OPERATOR LOCAL 14 | 1 | 0 |
| | 1 | CONCRETE PUMP OILER | 1 | 0 |
| TOTAL | 54 | | 20 | 17 |

CREW: 1HCWP
NAME: WATERPROOFING -SITE′ 1

| | | | | |
|---|---|---|---|---|
| | 1 | FOREMAN WATERPROOFING LOCAL 147 | 1 | |
| | 6 | MINER-WATERPROOFING LOCAL 147 | 6 | |
| TOTAL | 7 | | 7 | — |

CREW: 1HCARB
NAME: REBAR -SITE′ 1

| | | | | |
|---|---|---|---|---|
| | | LABOR | | |
| | 1 | FOREMAN REBAR LOCAL 147 | 1 | |
| | 14 | MINER-REBAR LOCAL 147 | 7 | 7 |
| TOTAL | 15 | | 8 | 7 |

[symbol]

indicates data missing or illegible when filed

The Reddi System LLC
CREW SHEET

| Crew 2 | | | | SHIFT WORK HOURS | | | | |
|---|---|---|---|---|---|---|---|---|
| G | D | S | G | STRAIGHT TIME | | OVERTIME | | TOTAL |
| Shift | Shift | Shift | Shift | PER MAN | TOTAL | PER MAN | TOTAL | HOURS |
| | | | | 8 | 8 | | | 8 |
| | | | | 8 | 8 | | | 8 |
| | | | | 8 | 8 | | | 8 |
| | | | | 8 | 24 | | | 24 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 16 | | | 16 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 16 | | | 16 |
| | | | | 8 | 16 | | | 16 |
| | | | | 8 | 8 | | | 8 |
| | | | | 8 | 24 | | | 24 |
| | | | | 8 | 16 | | | 16 |
| | | | | 8 | 16 | | | 16 |
| | | | | 8 | 8 | | | 8 |
| | | | | 8 | 8 | | | 8 |
| | | | | 8 | 16 | | | 16 |
| — | — | — | — | | | | | 296 |
| | | | | 8 | 8 | | | 8 |
| | | | | 8 | 8 | | | 8 |
| | | | | 8 | 8 | | | 8 |
| | | | | 8 | 24 | | | 24 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 16 | | | 16 |
| | | | | 8 | 8 | | | 8 |
| | | | | 8 | 8 | | | 8 |
| | | | | 8 | 16 | | | 16 |
| | | | | 8 | 24 | | | 24 |
| | | | | 8 | 8 | | | 8 |
| | | | | 8 | 24 | | | 24 |
| | | | | 8 | 16 | | | 16 |
| | | | | 8 | 16 | | | 16 |
| | | | | 8 | 8 | | | 8 |
| | | | | 8 | 8 | | | 8 |
| | | | | 8 | 16 | | | 16 |
| — | — | — | — | | | | | 272 |
| 1 | | | | 8 | 24 | | | 24 |
| 1 | — | — | — | | | — | — | 24 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 16 | | | 16 |
| | | | | 8 | 8 | | | 8 |
| | | | | 8 | 40 | | | 40 |
| | | | | 8 | 48 | | | 48 |
| | | | | 8 | 8 | | | 8 |
| | | | | 8 | 24 | | | 24 |
| — | — | — | — | | | | | 200 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 16 | | | 16 |
| | | | | 8 | 32 | | | 32 |
| | | | | 8 | 8 | | | 8 |
| | | | | 8 | 8 | | | 8 |
| | | | | 8 | 32 | | | 32 |
| | | | | 8 | 8 | | | 8 |
| | | | | 8 | 32 | | | 32 |
| | | | | 8 | 8 | | | 8 |
| | | | | 8 | 8 | | | 8 |
| | | | | 8 | 48 | | | 48 |
| | | | | 8 | 8 | | | 8 |
| | | | | 8 | 8 | | | 8 |
| | | | | 8 | 8 | | | 8 |
| | | | | 8 | 8 | | | 8 |
| | | | | 8 | 64 | | | 64 |
| — | — | — | — | | | | | 336 |
| | | | | 8 | 8 | | | 8 |
| | | | | 8 | 8 | | | 8 |
| | | | | 8 | 16 | | | 16 |
| — | — | — | — | 24 | 32 | | | 32 |

| [symbol] ORK HOURS | | | HOURLY WAGE RATE | CREW LABOR SHIFT COST | | |
|---|---|---|---|---|---|---|
| OVERTIME | | TOTAL | (w/WC INSUR.) | STRAIGHT | OVER | TOTAL |
| [symbol] ER MA [symbol] | TOTAL | HOURS | STRAIGHT OVERTIME | TIME | TIME | COST |

| | | | | |
|---|---|---|---|---|
| 8 | $98.31 | 786.48 | 0.00 | 786.48 |
| 32 | $94.08 | 3010.560 | 0.00 | 3,010.56 |
| 8 | $115.58 | 924.640 | 0.00 | 924.64 |
| 24 | $111.32 | 2671.680 | 0.00 | 2,671.68 |
| 16 | $70.64 | 1130.24 | 0.00 | 1,130.24 |
| 88 | $96.86 | | | 8,523.60 |

| HOURS | | DAILY | CREW |
|---|---|---|---|
| PER | TOTAL | RENTAL | EQUIPMENT |
| SHIFT | SHIFTS | RATE | COST |
| 8 | 0 | 0.00 | — |
| 8 | 1 | 596.65 | 596.65 |
| | | | 596.65 |

| | Crew 2 | | | SHIFT WORK HOURS | | | | |
|---|---|---|---|---|---|---|---|---|
| G | D | S | G | STRAIGHT TIME | | OVERTIME | | TOTAL |
| Shift | Shift | Shift | Shift | PER MAN | TOTAL | PER MAN | TOTAL | HOURS |
| 1 | | | | 8 | 24 | | | 24 |
| 1 | — | — | — | | | | | 24 |
| 1 | | | | 8 | 24 | | | 24 |
| 1 | | | | 8 | 24 | | | 24 |
| 6 | | | | 8 | 144 | | | 144 |
| 6 | | | | 8 | 144 | | | 144 |
| 2 | | | | 8 | 48 | | | 48 |
| 1 | | | | 8 | 24 | | | 24 |
| 1 | | | | 8 | 24 | | | 24 |
| 1 | | | | 8 | 24 | | | 24 |
| 1 | | | | 8 | 24 | | | 24 |
| 20 | — | — | — | | | | | 480 |
| 1 | 1 | 1 | 1 | 8 | 48 | | | 48 |
| 1 | 1 | 1 | 1 | 8 | 48 | | | 48 |
| 7 | 7 | 7 | 7 | 8 | 336 | | | 336 |
| 7 | 7 | 7 | 7 | 8 | 336 | | | 336 |
| 1 | 1 | 1 | 1 | 8 | 48 | | | 48 |
| 1 | 1 | 1 | 1 | 8 | 48 | | | 48 |
| 1 | 1 | 1 | 1 | 8 | 48 | | | 48 |
| 1 | 0 | 0 | 0 | 8 | 24 | | | 24 |
| 1 | 1 | 1 | 1 | 8 | 48 | | | 48 |
| 1 | 1 | 1 | 1 | 8 | 48 | | | 48 |
| 1 | | | 1 | 8 | 16 | | | 16 |
| 23 | 21 | 21 | 22 | | | | | 1,048 |

CAVATION-SITE 1

| | | | | | | |
|---|---|---|---|---|---|---|
| 0 | | | | 8 | 8 | 8 |
| 0 | | | | 8 | 8 | 8 |
| 1 | | | | 8 | 24 | 24 |
| 1 | | | | 8 | 24 | 24 |
| 1 | | | | 8 | 24 | 24 |
| 2 | | | | 8 | 64 | 64 |
| 1 | | | | 8 | 24 | 24 |
| 1 | | | | 8 | 24 | 24 |
| 0 | | | | 8 | 8 | 8 |
| 0 | | | | 8 | 8 | 8 |
| 2 | | | | 8 | 56 | 56 |
| 1 | | | | 8 | 24 | 24 |
| | | | | 8 | 16 | 16 |
| 1 | | | | 8 | 24 | 24 |
| 0 | | | | 8 | 8 | 8 |
| 1 | | | | 8 | 32 | 32 |
| 1 | | | | 8 | 24 | 24 |
| 0 | | | | 8 | 8 | 8 |
| 0 | | | | 8 | 16 | 16 |
| 13 | — | — | — | | | 424 |

[symbol]

CKING

| | | | | | | |
|---|---|---|---|---|---|---|
| 1 | | | | 8 | 32 | 32 |
| 1 | | | | 8 | 24 | 24 |
| 10 | | | | 8 | 240 | 240 |
| 1 | | | | 8 | 24 | 24 |
| 1 | | | | 8 | 24 | 24 |
| 1 | | | | 8 | 24 | 24 |
| 1 | | | | 8 | 24 | 24 |
| | | | | 8 | 0 | 0 |
| | | | | 8 | 0 | 0 |
| 2 | | | | 8 | 48 | 48 |
| 0 | | | | 8 | 16 | 16 |
| 1 | | | | 8 | 8 | 8 |
| 1 | | | | 8 | 8 | 8 |
| | | | | 8 | 8 | 8 |
| 20 | — | — | — | | | 480 |
| 1 | | | | 8 | 32 | 32 |
| 1 | | | | 8 | 24 | 24 |
| 6 | | | | 8 | 144 | 144 |
| 2 | | | | 8 | 48 | 48 |
| 2 | | | | 8 | 48 | 48 |
| 1 | | | | 8 | 24 | 24 |
| 0 | | | | 8 | 16 | 16 |
| 0 | | | | 8 | 16 | 16 |
| 0 | | | | 8 | 16 | 16 |
| 1 | | | | 8 | 8 | 8 |
| 1 | | | | 8 | 8 | 8 |
| 15 | — | — | — | | | 384 |
| | | | | 8 | 16 | 16 |
| | | | | 8 | 16 | 16 |
| | | | | 8 | 16 | 16 |
| | | | | 8 | 16 | 16 |
| | | | | 8 | 64 | 64 |
| | | | | 8 | 16 | 16 |
| | | | | 8 | 16 | 16 |
| | | | | 8 | 16 | 16 |
| | | | | 8 | 16 | 16 |
| | | | | 8 | 40 | 40 |
| | | | | 8 | 32 | 32 |
| | | | | 8 | 16 | 16 |
| | | | | 8 | 32 | 32 |
| | | | | 8 | 16 | 16 |
| | | | | 8 | 8 | 8 |
| | | | | 8 | 24 | 24 |
| | | | | 8 | 8 | 8 |
| | | | | 8 | 8 | 8 |
| — | — | — | — | | | 376 |
| | | | | 8 | 24 | 24 |
| | | | | 8 | 16 | 16 |
| | | | | 8 | 64 | 64 |
| | | | | 8 | 16 | 16 |
| | | | | 8 | 16 | 16 |
| | | | | 8 | 32 | 32 |
| | | | | 8 | 32 | 32 |
| | | | | 8 | 64 | 64 |
| | | | | 8 | 16 | 16 |
| | | | | 8 | 16 | 16 |
| | | | | 8 | 16 | 16 |
| — | — | — | — | | | 312 |
| 1 | | | | 8 | 24 | 24 |
| 1 | | | | 8 | 24 | 24 |
| 1 | | | | 8 | 24 | 24 |
| 1 | | | | 8 | 24 | 24 |
| 1 | | | | 8 | 24 | 24 |
| 0 | | | | 8 | 8 | 8 |
| 1 | | | | 8 | 24 | 24 |
| 1 | | | | 8 | 24 | 24 |
| 0 | | | | 8 | 8 | 8 |
| 1 | | | | 8 | 24 | 24 |
| 2 | | | | 8 | 64 | 64 |
| 1 | | | | 8 | 24 | 24 |
| 2 | | | | 8 | 48 | 48 |
| 1 | | | | 8 | 24 | 24 |
| 2 | | | | 8 | 48 | 48 |
| 2 | | | | 8 | 56 | 56 |
| 2 | | | | 8 | 48 | 48 |
| 0 | | | | 8 | 8 | 8 |
| 2 | | | | 8 | 64 | 64 |
| 2 | | | | 8 | 48 | 48 |
| | | | | 8 | 8 | 8 |
| 1 | | | | 8 | 24 | 24 |
| 0 | | | | 8 | 16 | 16 |
| 25 | — | — | — | | | 688 |
| 1 | 2 | 1 | 1 | 8 | 64 | 64 |
| 1 | 1 | 1 | 1 | 8 | 48 | 48 |
| 2 | 2 | 2 | 2 | 8 | 96 | 96 |
| 1 | 1 | 1 | 1 | 8 | 48 | 48 |
| 2 | 2 | 2 | 2 | 8 | 96 | 96 |
| | 1 | 0 | 0 | 8 | 16 | 16 |
| | 4 | 0 | 0 | 8 | 64 | 64 |
| 1 | 1 | 1 | 1 | 8 | 48 | 48 |
| 4 | 4 | 4 | 4 | 8 | 192 | 192 |
| 1 | 1 | 1 | 1 | 8 | 48 | 48 |
| 1 | 1 | 1 | 1 | 8 | 48 | 48 |
| 3 | 3 | 3 | 3 | 8 | 144 | 144 |
| 3 | 3 | 3 | 3 | 8 | 144 | 144 |
| 2 | 2 | 2 | 2 | 8 | 96 | 96 |
| 2 | 2 | 2 | 2 | 8 | 96 | 96 |
| 24 | 30 | 24 | 24 | | | 1,248 |
| | | | | 8 | 8 | 8 |
| | | | | 8 | 8 | 8 |
| 1 | | | | 8 | 24 | 24 |
| 1 | | | | 8 | 24 | 24 |
| 1 | | | | 8 | 24 | 24 |
| 2 | | | | 8 | 48 | 48 |
| 1 | | | | 8 | 24 | 24 |
| 1 | | | | 8 | 24 | 24 |
| 0 | | | | 8 | 8 | 8 |
| | | | | 8 | 8 | 8 |
| | | | | 8 | 16 | 16 |
| 2 | | | | 8 | 56 | 56 |
| 2 | | | | 8 | 48 | 48 |
| 1 | | | | 8 | 24 | 24 |
| 0 | | | | 8 | 8 | 8 |
| 1 | | | | 8 | 32 | 32 |
| 0 | | | | 8 | 8 | 8 |
| 1 | | | | 8 | 24 | 24 |
| 14 | — | — | — | | | 416 |
| 1 | | | | 8 | 32 | 32 |
| 1 | | | | 8 | 24 | 24 |
| 8 | | | | 8 | 208 | 208 |
| 1 | | | | 8 | 24 | 24 |
| 2 | | | | 8 | 48 | 48 |
| 2 | | | | 8 | 48 | 48 |
| 0 | | | | 8 | 16 | 16 |
| 0 | | | | 8 | 16 | 16 |
| 0 | | | | 8 | 16 | 16 |
| 15 | — | — | — | | | 432 |
| 1 | | | | 8 | 24 | 24 |
| 1 | | | | 8 | 24 | 24 |
| 1 | | | | 8 | 24 | 24 |
| 1 | | | | 8 | 24 | 24 |
| 1 | | | | 8 | 24 | 24 |
| 1 | | | | 8 | 32 | 32 |
| 0 | | | | 8 | 16 | 16 |
| | | | | 8 | 16 | 16 |
| | | | | 8 | 32 | 32 |
| 3 | | | | 8 | 72 | 72 |
| 2 | | | | 8 | 48 | 48 |
| 1 | | | | 8 | 24 | 24 |
| 0 | | | | 8 | 8 | 8 |
| 2 | | | | 8 | 64 | 64 |
| 0 | | | | 8 | 8 | 8 |
| 1 | | | | 8 | 24 | 24 |
| 15 | — | — | — | | | 464 |
| 1 | | | | 8 | 32 | 32 |
| 1 | | | | 8 | 24 | 24 |
| 8 | | | | 8 | 192 | 192 |
| 1 | | | | 8 | 24 | 24 |
| 1 | | | | 8 | 24 | 24 |
| 1 | | | | 8 | 24 | 24 |
| 2 | | | | 8 | 48 | 48 |
| 2 | | | | 8 | 48 | 48 |
| | | | | 8 | 0 | 0 |
| | | | | 8 | 0 | 0 |
| 0 | | | | 8 | 16 | 16 |
| 0 | | | | 8 | 16 | 16 |
| 0 | | | | 8 | 16 | 16 |
| 17 | — | — | — | | | 464 |
| 1 | | | | 8 | 24 | 24 |
| 1 | | | | 8 | 24 | 24 |
| 8 | | | | 8 | 192 | 192 |
| 1 | | | | 8 | 24 | 24 |
| 2 | | | | 8 | 48 | 48 |
| 1 | | | | 8 | 24 | 24 |
| 1 | | | | 8 | 24 | 24 |
| 2 | | | | 8 | 48 | 48 |
| 0 | | | | 8 | 8 | 8 |
| 0 | | | | 8 | 8 | 8 |
| 0 | | | | 8 | 8 | 8 |
| 17 | — | — | — | | | 432 |
| | | | | 8 | 8 | 8 |
| | | | | 8 | 48 | 48 |
| — | — | — | — | | | 56 |
| | | | | 8 | 8 | 8 |
| | | | | 8 | 112 | 112 |
| — | — | — | — | | | 120 |

[symbol]

indicates data missing or illegible when filed

| HOURLY WAGE RATE | | CREW LABOR SHIFT COST | | |
|---|---|---|---|---|
| (WITH WC INSUR.) | | STRAIGHT | OVER | TOTAL |
| 6 DAY WEEK RATE | OVERTIME | TIME | TIME | COST |
| $147.99 | | 1183.89 | 0.00 | 1,183.89 |
| $117.00 | | 936.00 | 0.00 | 936.00 |
| $139.44 | | 1115.49 | 0.00 | 1,115.49 |
| $88.24 | | 2117.85 | 0.00 | 2,117.85 |
| $88.24 | | 705.95 | 0.00 | 705.95 |
| $88.24 | | 705.95 | 0.00 | 705.95 |
| $92.52 | | 740.16 | 0.00 | 740.16 |
| $73.32 | | 586.54 | 0.00 | 586.54 |
| $73.32 | | 586.54 | 0.00 | 586.54 |
| $73.32 | | 586.54 | 0.00 | 586.54 |
| $49.84 | | 398.73 | 0.00 | 398.73 |
| $54.12 | | 432.92 | 0.00 | 432.92 |
| $45.60 | | 729.64 | 0.00 | 729.64 |
| $49.84 | | 398.73 | 0.00 | 398.73 |
| $30.68 | | 245.41 | 0.00 | 245.41 |
| $44.36 | | 354.90 | 0.00 | 354.90 |
| $37.05 | | 296.38 | 0.00 | 296.38 |
| $88.24 | | 705.95 | 0.00 | 705.95 |
| $41.33 | | 661.24 | 0.00 | 661.24 |
| $25.40 | | 406.42 | 0.00 | 406.42 |
| $101.47 | | 811.74 | 0.00 | 811.74 |
| $69.23 | | 1661.51 | 0.00 | 1,661.51 |
| $71.17 | | 1138.71 | 0.00 | 1,138.71 |
| $69.90 | | 1118.47 | 0.00 | 1,118.47 |
| $88.26 | | 706.06 | 0.00 | 706.06 |
| $71.79 | | 574.29 | 0.00 | 574.29 |
| $76.06 | | 1217.01 | 0.00 | 1,217.01 |
| 71.36 | | | | 21,123 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $147.99 | | 1183.89 | 0.00 | 1,183.89 |
| $117.00 | | 936.00 | 0.00 | 936.00 |
| $139.44 | | 1115.49 | 0.00 | 1,115.49 |
| $88.24 | | 2117.76 | 0.00 | 2,117.76 |
| $88.24 | | 705.95 | 705.95 | |
| $92.52 | | 740.16 | 0.00 | 740.16 |
| $73.32 | | 586.54 | 0.00 | 586.54 |
| $73.32 | | 586.54 | 0.00 | 586.54 |
| $73.32 | | 586.54 | 0.00 | 586.54 |
| $49.84 | | 398.73 | 0.00 | 398.73 |
| $54.12 | | 432.92 | 0.00 | 432.92 |
| $45.60 | | 729.64 | 0.00 | 729.64 |
| $47.05 | | 296.38 | 0.00 | 296.38 |
| $88.24 | | 705.95 | 0.00 | 705.95 |
| $41.33 | | 661.24 | 0.00 | 661.24 |
| $25.40 | | 609.63 | 0.00 | 609.63 |
| $101.47 | | 811.74 | 0.00 | 811.74 |
| $69.23 | | 1661.51 | 0.00 | 1,661.51 |
| $71.17 | | 1138.71 | 0.00 | 1,138.71 |
| $69.90 | | 1118.47 | 0.00 | 1,118.47 |
| $88.26 | | 706.06 | 0.00 | 706.06 |
| $71.79 | | 574.29 | 0.00 | 574.29 |
| $76.06 | | 1217.01 | 0.00 | 1,217.01 |
| 69.54 | | | | 18,915 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| 67.01 | | $1,608.14 | $0.00 | $1,608.14 |
| $67.01 | — | $1,608.1 | $0.0 | $1,608 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $93.22 | | 745.77 | 0.00 | 745.77 |
| $93.22 | | 745.77 | 0.00 | 745.77 |
| $92.67 | | 741.40 | 0.00 | 741.40 |
| $92.67 | | 741.40 | 0.00 | 741.40 |
| $92.67 | | 741.40 | 0.00 | 741.40 |
| $99.12 | | 792.98 | 0.00 | 792.98 |
| $89.50 | | 715.99 | 0.00 | 715.99 |
| $69.23 | | 1107.68 | 0.00 | 1,107.68 |
| $106.88 | | 855.07 | 0.00 | 855.07 |
| $102.95 | | 4118.08 | 0.00 | 4,118.08 |
| $102.95 | | 4941.69 | 0.00 | 4,941.69 |
| $96.00 | | 768.03 | 0.00 | 768.03 |
| $71.17 | | 1708.06 | 0.00 | 1,708.06 |
| 93.62 | | | | 18,723 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $100.65 | | 805.19 | 0.00 | 805.19 |
| $84.30 | | 674.41 | 0.00 | 674.41 |
| $72.89 | | 583.15 | 0.00 | 583.15 |
| $84.30 | | 674.41 | 0.00 | 674.41 |
| $92.67 | | 741.40 | 0.00 | 741.40 |
| $92.67 | | 1482.80 | 0.00 | 1,482.80 |
| $69.23 | | 2215.35 | 0.00 | 2,215.35 |
| $82.95 | | 663.63 | 0.00 | 663.63 |
| $99.12 | | 792.98 | 0.00 | 792.98 |
| $89.50 | | 2863.97 | 0.00 | 2,863.97 |
| $70.75 | | 565.96 | 0.00 | 565.96 |
| $67.47 | | 2158.99 | 0.00 | 2,158.99 |
| $69.90 | | 559.23 | 0.00 | 559.23 |
| $93.40 | | 747.22 | 0.00 | 747.22 |
| $89.50 | | 4295.96 | 0.00 | 4,295.96 |
| $94.80 | | 758.43 | 0.00 | 758.43 |
| $84.30 | | 674.41 | 0.00 | 674.41 |
| $71.17 | | 569.35 | 0.00 | 569.35 |
| $99.94 | | 799.48 | 0.00 | 799.48 |
| $96.00 | | 6144.20 | 0.00 | 6,144.20 |
| 85.63 | | | | 28,771 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $88.26 | 0 | $706.06 | 0.00 | $706.06 |
| 71.79 | 0 | $574.29 | 0 | $574.29 |
| 76.06 | 0 | $1,217.01 | 0 | $1,217.01 |
| $78.04 | | | | $2,497 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $84.30 | | 2023.24 | 0.00 | 2,023.24 |
| 84.30 | | | | $2,023 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $105.75 | | 2537.92 | 0.00 | 2,537.92 |
| $99.12 | | 2378.95 | 0.00 | 2,378.95 |
| $89.50 | | 12887.88 | 0.00 | 12,887.88 |
| $64.57 | | 9298.31 | 0.00 | 9,298.31 |
| $89.50 | | 4295.96 | 0.00 | 4,295.96 |
| $90.74 | | 2177.72 | 0.00 | 2,177.72 |
| $69.23 | | 1661.51 | 0.00 | 1,661.51 |
| $89.50 | | 2147.98 | 0.00 | 2,147.98 |
| $66.47 | | 1595.33 | 0.00 | 1,595.33 |
| 75.92 | | | | 36,444 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $105.75 | | 5075.85 | 0.00 | 5,075.85 |
| $99.12 | | 4757.89 | 0.00 | 4,757.89 |
| $89.50 | | 30071.72 | 0.00 | 30,071.72 |
| $64.57 | | 21696.07 | 0.00 | 21,696.07 |
| $89.50 | | 4295.96 | 0.00 | 4,295.96 |
| $85.75 | | 4116.21 | 0.00 | 4,116.21 |
| $90.74 | | 4355.44 | 0.00 | 4,355.44 |
| $89.50 | | 2147.98 | 0.00 | 2,147.98 |
| $66.47 | | 3190.66 | 0.00 | 3,190.66 |
| $96.19 | | 4617.17 | 0.00 | 4,617.17 |
| $93.93 | | 1502.83 | 0.00 | 1,502.83 |
| 77.05 | | | | 80,752 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $100.65 | | 805.19 | 0.00 | 805.19 |
| $84.30 | | 674.41 | 0.00 | 674.41 |
| $87.93 | | 2110.36 | 0.00 | 2,110.36 |
| $84.30 | | 2023.24 | 0.00 | 2,023.24 |
| $71.02 | | 1704.41 | 0.00 | 1,704.41 |
| $69.23 | | 4430.70 | 0.00 | 4,430.70 |
| $72.89 | | 1749.44 | 0.00 | 1,749.44 |
| $67.01 | | 1608.14 | 0.00 | 1,608.14 |
| $92.67 | | 741.40 | 0.00 | 741.40 |
| $92.67 | | 741.40 | 0.00 | 741.40 |
| $89.50 | | 5011.95 | 0.00 | 5,011.95 |
| $89.50 | | 2147.98 | 0.00 | 2,147.98 |
| $89.50 | | 1431.99 | 0.00 | 1,431.99 |
| $82.95 | | 1990.90 | 0.00 | 1,990.90 |
| $70.75 | | 565.96 | 0.00 | 565.96 |
| $67.47 | | 2158.99 | 0.00 | 2,158.99 |
| $93.22 | | 2237.30 | 0.00 | 2,237.30 |
| $69.90 | | 559.23 | 0.00 | 559.23 |
| $89.50 | | 1431.99 | 0.00 | 1,431.99 |
| 80.48 | | | | 34,125 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $105.75 | | 3383.90 | 0.00 | 3,383.90 |
| $99.12 | | 2378.95 | 0.00 | 2,378.95 |
| $89.50 | | 21479.80 | 0.00 | 21,479.80 |
| $89.50 | | 2147.98 | 0.00 | 2,147.98 |
| $89.50 | | 2147.98 | 0.00 | 2,147.98 |
| $89.50 | | 2147.98 | 0.00 | 2,147.98 |
| $85.75 | | 2058.11 | 0.00 | 2,058.11 |
| $93.40 | | 0.00 | 0.00 | — |
| $89.50 | | 0.00 | 0.00 | — |
| $89.50 | | 4295.96 | 0.00 | 4,295.96 |
| $66.47 | | 1063.55 | 0.00 | 1,063.55 |
| $93.93 | | 751.41 | 0.00 | 751.41 |
| $89.50 | | 715.99 | 0.00 | 715.99 |
| $96.19 | | 769.53 | 0.00 | 769.53 |
| 83.24 | | | | 39,957 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $105.75 | | 3383.90 | 0.00 | 3,383.90 |
| $99.12 | | 2378.95 | 0.00 | 2,378.95 |
| $89.50 | | 12887.88 | 0.00 | 12,887.88 |
| $89.50 | | 4295.96 | 0.00 | 4,295.96 |
| $85.75 | | 4116.21 | 0.00 | 4,116.21 |
| $89.50 | | 2147.98 | 0.00 | 2,147.98 |
| $90.74 | | 1451.81 | 0.00 | 1,451.81 |
| $96.19 | | 1539.06 | 0.00 | 1,539.06 |
| $66.47 | | 1063.55 | 0.00 | 1,063.55 |
| $93.93 | | 751.41 | 0.00 | 751.41 |
| $89.50 | | 715.99 | 0.00 | 715.99 |
| 81.64 | | | | 31,349 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $100.65 | | 1610.37 | 0.00 | 1,610.37 |
| $84.30 | | 1348.82 | 0.00 | 1,348.82 |
| $87.93 | | 1406.90 | 0.00 | 1,406.90 |
| $71.02 | | 1136.27 | 0.00 | 1,136.27 |
| $69.23 | | 4430.70 | 0.00 | 4,430.70 |
| $72.89 | | 1166.30 | 0.00 | 1,166.30 |
| $92.67 | | 1482.80 | 0.00 | 1,482.80 |
| $84.30 | | 1348.82 | 0.00 | 1,348.82 |
| $67.01 | | 1072.09 | 0.00 | 1,072.09 |
| $89.50 | | 3579.97 | 0.00 | 3,579.97 |
| $89.50 | | 2863.97 | 0.00 | 2,863.97 |
| $99.12 | | 1585.96 | 0.00 | 1,585.96 |
| $89.50 | | 2863.97 | 0.00 | 2,863.97 |
| $82.95 | | 1327.27 | 0.00 | 1,327.27 |
| $70.75 | | 565.96 | 0.00 | 565.96 |
| $67.47 | | 1619.24 | 0.00 | 1,619.24 |
| $93.22 | | 745.77 | 0.00 | 745.77 |
| $69.90 | | 559.23 | 0.00 | 559.23 |
| 81.69 | | | | 30,714 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $105.75 | | 2537.92 | 0.00 | 2,537.92 |
| $99.12 | | 1585.96 | 0.00 | 1,585.96 |
| $89.50 | | 5727.95 | 0.00 | 5,727.95 |
| $89.50 | | 1431.99 | 0.00 | 1,431.99 |
| $99.12 | | 1585.96 | 0.00 | 1,585.96 |
| $89.50 | | 2863.97 | 0.00 | 2,863.97 |
| $89.50 | | 2863.97 | 0.00 | 2,863.97 |
| $85.75 | | 5488.28 | 0.00 | 5,488.28 |
| $100.09 | | 1601.49 | 0.00 | 1,601.49 |
| $84.30 | | 1348.82 | 0.00 | 1,348.82 |
| $109.61 | | 1753.71 | 0.00 | 1,753.71 |
| 84.14 | | | | 26,252 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $100.65 | | 2415.56 | 0.00 | 2,415.56 |
| $84.30 | | 2023.24 | 0.00 | 2,023.24 |
| $87.93 | | 2110.36 | 0.00 | 2,110.36 |
| $84.30 | | 2023.24 | 0.00 | 2,023.24 |
| $72.89 | | 1749.44 | 0.00 | 1,749.44 |
| $84.30 | | 674.41 | 0.00 | 674.41 |
| $67.01 | | 1608.14 | 0.00 | 1,608.14 |
| $92.67 | | 2224.20 | 0.00 | 2,224.20 |
| $92.67 | | 741.40 | 0.00 | 741.40 |
| $71.02 | | 1704.41 | 0.00 | 1,704.41 |
| $69.23 | | 4430.70 | 0.00 | 4,430.70 |
| $69.23 | | 1661.51 | 0.00 | 1,661.51 |
| $69.23 | | 3323.03 | 0.00 | 3,323.03 |
| $69.23 | | 1661.51 | 0.00 | 1,661.51 |
| $82.95 | | 3981.80 | 0.00 | 3,981.80 |
| $89.50 | | 5011.95 | 0.00 | 5,011.95 |
| $89.50 | | 4295.96 | 0.00 | 4,295.96 |
| $70.75 | | 565.96 | 0.00 | 565.96 |
| $67.47 | | 4317.98 | 0.00 | 4,317.98 |
| $93.22 | | 4474.61 | 0.00 | 4,474.61 |
| $99.94 | | 799.48 | 0.00 | 799.48 |
| $96.00 | | 2304.08 | 0.00 | 2,304.08 |
| $69.90 | | 1118.47 | 0.00 | 1,118.47 |
| 80.26 | | | | 55,221 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $105.75 | | 6767.80 | 0.00 | 6,767.80 |
| $99.12 | | 4757.89 | 0.00 | 4,757.89 |
| $89.50 | | 8591.92 | 0.00 | 8,591.92 |
| $99.12 | | 4757.89 | 0.00 | 4,757.89 |
| $89.50 | | 8591.92 | 0.00 | 8,591.92 |
| $93.40 | | 1494.45 | 0.00 | 1,494.45 |
| $89.50 | | 5727.95 | 0.00 | 5,727.95 |
| $99.12 | | 4757.89 | 0.00 | 4,757.89 |
| $89.50 | | 17183.84 | 0.00 | 17,183.84 |
| $93.93 | | 4508.49 | 0.00 | 4,508.49 |
| $89.50 | | 4295.96 | 0.00 | 4,295.96 |
| $87.93 | | 12662.14 | 0.00 | 12,662.14 |
| $89.50 | | 12887.88 | 0.00 | 12,887.88 |
| $69.23 | | 6646.05 | 0.00 | 6,646.05 |
| $89.50 | | 8591.92 | 0.00 | 8,591.92 |
| 84.50 | | | | 105,456 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $100.65 | | 805.19 | 0.00 | 805.19 |
| $84.30 | | 674.41 | 0.00 | 674.41 |
| $87.93 | | 2110.36 | 0.00 | 2,110.36 |
| $84.30 | | 2023.24 | 0.00 | 2,023.24 |
| $71.02 | | 1704.41 | 0.00 | 1,704.41 |
| $69.23 | | 3323.03 | 0.00 | 3,323.03 |
| $72.89 | | 1749.44 | 0.00 | 1,749.44 |
| $67.01 | | 1608.14 | 0.00 | 1,608.14 |
| $92.67 | | 741.40 | 0.00 | 741.40 |
| $99.12 | | 792.98 | 0.00 | 792.98 |
| $89.50 | | 1431.99 | 0.00 | 1,431.99 |
| $89.50 | | 5011.95 | 0.00 | 5,011.95 |
| $89.50 | | 4295.96 | 0.00 | 4,295.96 |
| $82.95 | | 1990.90 | 0.00 | 1,990.90 |
| $70.75 | | 565.96 | 0.00 | 565.96 |
| $67.47 | | 2158.99 | 0.00 | 2,158.99 |
| $69.90 | | 559.23 | 0.00 | 559.23 |
| $93.22 | | 2237.30 | 0.00 | 2,237.30 |
| 81.21 | | | | 33,785 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $105.75 | | 3383.90 | 0.00 | 3,383.90 |
| $99.12 | | 2378.95 | 0.00 | 2,378.95 |
| $89.50 | | 18615.83 | 0.00 | 18,615.83 |
| $89.50 | | 2147.98 | 0.00 | 2,147.98 |
| $85.75 | | 4116.21 | 0.00 | 4,116.21 |
| $89.50 | | 4295.96 | 0.00 | 4,295.96 |
| $67.01 | | 1072.09 | 0.00 | 1,072.09 |
| $93.93 | | 1502.83 | 0.00 | 1,502.83 |
| $84.30 | | 1348.82 | 0.00 | 1,348.82 |
| 82.13 | | | | 35,479 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $87.93 | | 2110.36 | 0.00 | 2,110.36 |
| $84.30 | | 2023.24 | 0.00 | 2,023.24 |
| $72.89 | | 1749.44 | 0.00 | 1,749.44 |
| $67.01 | | 1608.14 | 0.00 | 1,608.14 |
| $71.02 | | 1704.41 | 0.00 | 1,704.41 |
| $69.23 | | 2215.35 | 0.00 | 2,215.35 |
| $92.67 | | 1482.80 | 0.00 | 1,482.80 |
| $99.12 | | 1585.96 | 0.00 | 1,585.96 |
| $89.50 | | 2863.97 | 0.00 | 2,863.97 |
| $89.50 | | 6443.94 | 0.00 | 6,443.94 |
| $89.50 | | 4295.96 | 0.00 | 4,295.96 |
| $82.95 | | 1990.90 | 0.00 | 1,990.90 |
| $70.75 | | 565.96 | 0.00 | 565.96 |
| $67.47 | | 4317.98 | 0.00 | 4,317.98 |
| $69.90 | | 559.23 | 0.00 | 559.23 |
| $93.22 | | 2237.30 | 0.00 | 2,237.30 |
| 81.37 | | | | 37,755 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $105.75 | | 3383.90 | 0.00 | 3,383.90 |
| $99.12 | | 2378.95 | 0.00 | 2,378.95 |
| $89.50 | | 17183.84 | 0.00 | 17,183.84 |
| $89.50 | | 2147.98 | 0.00 | 2,147.98 |
| $87.93 | | 2110.36 | 0.00 | 2,110.36 |
| $89.50 | | 2147.98 | 0.00 | 2,147.98 |
| $85.75 | | 4116.21 | 0.00 | 4,116.21 |
| $89.50 | | 4295.96 | 0.00 | 4,295.96 |
| $93.40 | | 0.00 | 0.00 | — |
| $89.50 | | 0.00 | 0.00 | — |
| $93.93 | | 1502.83 | 0.00 | 1,502.83 |
| $84.30 | | 1348.82 | 0.00 | 1,348.82 |
| $67.01 | | 1072.09 | 0.00 | 1,072.09 |
| 82.55 | | | | 38,305 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $105.75 | | 2537.92 | 0.00 | 2,537.92 |
| $99.12 | | 2378.95 | 0.00 | 2,378.95 |
| $89.50 | | 17183.84 | 0.00 | 17,183.84 |
| $89.50 | | 2147.98 | 0.00 | 2,147.98 |
| $87.93 | | 4220.71 | 0.00 | 4,220.71 |
| $89.50 | | 2147.98 | 0.00 | 2,147.98 |
| $85.75 | | 2058.11 | 0.00 | 2,058.11 |
| $89.50 | | 4295.96 | 0.00 | 4,295.96 |
| $67.01 | | 536.05 | 0.00 | 536.05 |
| $93.93 | | 751.41 | 0.00 | 751.41 |
| $84.30 | | 674.41 | 0.00 | 674.41 |
| 84.25 | | | | 36,395 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $99.12 | | 792.98 | 0.00 | 792.98 |
| $89.50 | | 4295.96 | 0.00 | 4,295.96 |
| 90.87 | | | | 5,089 |
| HOURLY WAGE RATE | | CREW LABOR SHIFT COST | | |
| (WITH WC INSUR.) | | STRAIGHT | OVER | TOTAL |
| 6 DAY WEEK RATE | OVERTIME | TIME | TIME | COST |
| $99.12 | | 792.98 | 0.00 | 792.98 |
| $89.50 | | 10023.91 | 0.00 | 10,023.91 |
| 90.14 | | | | 10,817 |

THE REDDI SYSTEM LLC
7. MATERIAL DATA

| | | | |
|---|---|---|---|
| Material code | Description | Unit | Unit price |

Job Materials

| | | | |
|---|---|---|---|
| JE1010 | Explosives | | |
| JE1011 | Powder Delivery Charge | DAY | $3,850.00 |
| JE1012 | Powder | LBS | $7.70 |
| JE1013 | Powder Caps | EA | $8.40 |
| JE1014 | Misc Blasting Supplies | BCY | $4.83 |
| JE1015 | Drill bits | LF | $1.80 |
| JC1010 | Forms | SF | $2.00 |
| JC1011 | Water stops | LF | $0.50 |
| JC1012 | Keyways | LF | $2.00 |
| JC1013 | Reinforcing Steel Waste @ +5% | LBS | $0.05 |
| | Waste | | |
| JC1014 | Pipe Rail & Supports | LF | $1.70 |

Permanent Material

| | | | |
|---|---|---|---|
| PE1010 | #9 Bar Rock Bolts w/Hardware, 368 | LF | $2.00 |
| | Each × 12′ Long | | |
| PE1011 | Steel ribs/Channel W8 × 48, 8 Each | LBS | $5.00 |
| PE1012 | Steel rib plates, bolts and accessories | LBS | $5.00 |
| PE1013 | Permanent Shotcrete, SFR | CY | $105.00 |
| PC1010 | 2000 PSI Lean Concrete | CY | $90.00 |
| PC1011 | Water stops | LF | $2.00 |
| PC1012 | Asphalt Impregnated Protection | SF | $0.15 |
| | Board, ¼″ Thick (+10% | | |
| | Waste) | | |
| PC1013 | PVC Waterproofing Geomembrane, | SF | $1.50 |
| | 2.50 mm Thick (+10% Waste) | | |
| PC1014 | Reinforcing Steel | LBS | $0.45 |
| PC1015 | Rebar Placing Accessories | LBS | $0.05 |
| PC1016 | Concrete, 5000 PSI | CY | $130.00 |
| PC1017 | Miscellaneous Concrete Supplies | CY | $13.50 |
| PC1018 | Cement | SF | $1.70 |

Round Water Treatment Plant

| Equipment | | | | Rent per | Total/3 | Fuel-lube- | Total/3 |
|---|---|---|---|---|---|---|---|
| code | Equipment | Qty | Unit | hr. | shift | parts/hr | shifts |
| | | 978.99271 | days | | | | |
| P01010 | 30 HP SUBM PUMP 4″ EL | 1 | EA | $1.38 | $33 | $0.69 | $6 |
| P01011 | 90 HP SUBM PUMP 8″ EL | 1 | EA | $3.37 | $81 | $1.69 | $13 |
| P01012 | WATER TREATMENT PLANT | 1 | EA | $54.40 | $1,306 | $50.00 | $400 |
| | Total cost | | | | $1,420 | | $419 |
| | Average per day | | | | | | |
| | Average hrly rate | | | | $59 | | $17 |
| | | | | Rent | | Fuel -lube- | |
| | | | | | | parts | |
| Equipment | Equipment | Qty | Unit | Rent per | Total/1 | Fuel -lube- | Total/3 |
| code | | | | hr. | shift | parts/hr | shifts |

Mobilization - 1 Shift
FIELD OFFICE

| | | | | | | | |
|---|---|---|---|---|---|---|---|
| | | 979 | Days | | | | |
| | | 50 | Days | | | | |
| M01010 | Warehouse 20 × 40 | 1200 | SF | — | | $52.28 | $52 |
| M01011 | Office Trailers- Double | 2 | EA | — | | $54.65 | $55 |
| M01012 | Shop Building 20 × 40 | 1 | EA | — | | $235.15 | $235 |
| M01013 | Office Complex- 60 × 60 | 5000 | SF | — | | $290.84 | $291 |
| S01010 | 35 Ton Picker | 2 | EA | $46.60 | $374 | $24.00 | $192 |
| S01011 | Flat bed- 8 Ton | 1 | EA | $2.40 | $19 | $5.89 | $47 |
| S01012 | Compressor-185 cfm Diesel | 2 | EA | $1.50 | $12 | $8.65 | $69 |
| S01013 | Generator 125 KW | 1 | EA | $7.80 | $62 | $16.37 | $131 |
| S01014 | Pick ups ¾ Ton | 4 | EA | $7.20 | $58 | $17.30 | $138 |
| S01015 | Sedans-4 Door | 2 | EA | $0.96 | $8 | $5.06 | $40 |
| S01016 | Welder-Diesel- 400 amp | 2 | EA | $0.84 | $7 | $26.64 | $213 |
| S01017 | Back hoe-JD 710 | 1 | EA | $9.60 | $77 | $11.40 | $91 |
| S01018 | CAT 950 Loaders | 1 | EA | $9.60 | $77 | $13.39 | $107 |
| S01019 | Electric- 50 HP | 2 | EA | $— | | $13.20 | $106 |
| S01020 | Water | 1 | LS | $— | | $1.88 | $15 |
| | Total cost | | | | $694 | | $1,783 |
| | Average per day | | | | | | |
| | Average hrly rate | | | | $29 | | $74 |

Yard Equipment
Yard Service

| | | 197 | Days | | | | |
|---|---|---|---|---|---|---|---|
| S01010 | 35 Ton Picker | 2 | EA | $46.80 | $374 | $24.00 | $192 |
| S01021 | Tractor & Trailer | 3 | EA | $32.63 | $261 | $60.68 | $485 |
| S01012 | Compressor - 185 cfm Diesel | 2 | EA | $1.50 | $12 | $8.65 | $69 |
| S01022 | Rebar Bending Table | 2 | EA | $14.40 | $115 | $6.36 | $51 |
| S01014 | Pick ups ¾ Ton | 4 | EA | $7.20 | $58 | $17.30 | $138 |
| S01015 | Sedans - 4 Door | 2 | EA | $0.96 | $8 | $5.06 | $40 |
| S01016 | Welder - Diesel - 400 amp | 2 | EA | $0.84 | $7 | $26.64 | $213 |
| | Total cost | | | | $835 | | $1,190 |
| | Average per day | | | | | | |
| | Average hrly rate | | | | $35 | | $50 |
| | | | | Rent | | Fuel -lube- | |
| | | | | | | parts | |
| Equipment | Equipment | Qty | Unit | Rent per | Total/3 | Fuel -lube- | Total/3 |
| code | | | | hr. | shifts | parts/ hr | shifts |

Surface Equipment

| | | | | | | | |
|---|---|---|---|---|---|---|---|
| | | 979 | Days | | | | |
| S01023 | 4100 Manitowoc | 1 | EA | $242.68 | $5,824 | $57.80 | $1,387 |
| S01010 | 35 Ton Picker | 2 | EA | $46.80 | $1,123 | $24.00 | $576 |
| S01011 | Flat bed - 8 Ton | 1 | EA | $2.40 | $58 | $5.89 | $141 |
| S01012 | Compressor - 185 cfm Diesel | 2 | EA | $1.50 | $36 | $8.65 | $208 |
| S01024 | Generator 365 KW Standby No | 1 | EA | $10.20 | $245 | $— | $— |
| S01014 | Pick ups ¾ Ton | 6 | EA | $10.80 | $86 | $25.96 | $623 |
| S01015 | Sedans - 4 Door | 2 | EA | $0.96 | $8 | $5.06 | $121 |
| S01016 | Welder - Diesel - 400 amp | 4 | EA | $1.68 | $40 | $53.28 | $1,279 |
| S01025 | Welder - Electrical | 4 | EA | $3.60 | $86 | $13.20 | $317 |
| S01018 | CAT 988 Loaders | 1 | EA | $9.60 | $230 | $13.39 | $321 |
| S01026 | Platform Scale - 50 Ton | 1 | EA | $8.40 | $202 | $0.75 | $18 |
| S01027 | Man hoist | 1 | EA | $67.20 | $1,613 | $31.20 | $749 |
| S01028 | Vertical Belt Conveyor | 1 | EA | $48.00 | $1,152 | $14.65 | $352 |
| S01029 | Stacker | 1 | EA | $12.00 | $288 | $3.51 | $84 |
| S01030 | Dump Station (2 ea) | 2 | EA | $2.40 | $58 | $3.00 | $72 |
| | Total cost per days | | | | $11,049 | | $4,686 |
| | Average per day | | | | | | |
| | Average hrly rate | | | | $460 | | $195 |

TBM Excavation
Tunnel

| | | | | | | | |
|---|---|---|---|---|---|---|---|
| | | 297 | Days | | | | |
| HET10 | TBM-22′Dia | 1 | EA | $1,183.18 | $28,396 | $540.00 | $12,960 |
| HET11 | Locomotive - 35 Ton | 3 | EA | $108.00 | $2,592 | $54.00 | $1,296 |
| HET11 | Locomotive - 35 Ton | 1 | EA | $36.00 | $864 | $18.00 | $432 |
| HET12 | Muck Cars- 18 CY | 25 | EA | $52.50 | $1,260 | $46.50 | $1,116 |
| HET13 | 200 HP Vent Fan | 3 | EA | $1.98 | $48 | $41.22 | $989 |
| HET14 | Man trip cars | 4 | EA | $7.20 | $173 | $1.80 | $43 |
| HET15 | Flat Cars | 6 | EA | $10.80 | $259 | $2.16 | $52 |
| HET16 | Segment Cars | 20 | EA | $24.00 | $576 | $7.80 | $187 |
| HET17 | 4″ Submersible Pumps - electric | 5 | EA | $5.40 | $130 | $11.70 | $281 |
| HET18 | Moran 6 CY Concrete car - Elec [symbol] | 2 | EA | $18.00 | $432 | $5.94 | $143 |
| HET19 | Calif. Switches | 1 | EA | $42.00 | $1,008 | $3.00 | $72 |
| HET20 | Grout Pump & Mixture | 1 | EA | $33.00 | $792 | $6.00 | $144 |
| | Total cost | | | | $36,529 | | $17,715 |
| | Average per day | | | | | | |
| | Average hrly rate | | | | $1,522 | | $738 |

D & B Excavation (Adit, Starter, Tail Tunnels, S. InteBlocking & (Cross Passages)

| | | | | | | | |
|---|---|---|---|---|---|---|---|
| S01018 | CAT 988 Loader | 1 | EA | $9.60 | $230 | $13.39 | $321 |
| S01018 | CAT 988 Loader | 1 | EA | $9.60 | $230 | | |
| HED10 | 6 Boom Drill Jumbo | 2 | EA | $372.00 | $8,928 | $2.40 | $58 |
| S01025 | Welders - Electric | 2 | EA | $1.80 | $43 | $6.60 | $158 |
| HED11 | Compressor 1200 cfm | 2 | EA | $21.60 | $518 | $37.25 | $894.00 |
| HET20 | Grout Pump Mixer | 2 | EA | $66.00 | $1,584 | $12.00 | $288 |
| HET17 | 4″ Submersible pump | 4 | EA | $4.32 | $104 | $9.36 | $225 |
| HED13 | Hydraulic Track w/12′ Feed | 3 | EA | $54.00 | $1,296 | $79.74 | $1,914 |
| HED 14 | 2″ Submersible pump - 2 Hp | 4 | EA | $0.96 | $23 | $0.58 | $14 |
| HED 15 | Shot Crete Pump | 2 | EA | $9.60 | $230 | $9.60 | $230 |
| | Total cost per days | | | | $13,188 | | $4,102 |
| | Average per day | | | | | | |
| | Average hrly rate | | | | $550 | | $171 |

Concrete (Starter, Tail Tunnels, Interlocking & Cross Passages)

| | | | | | | | |
|---|---|---|---|---|---|---|---|
| | | | Days | | | | |
| | | 197 | Days | | | | |
| HCD10 | Scissor Lift Rack | 2 | EA | $9.60 | $230 | $3.00 | $72 |
| | Mounted | | | | | | |
| S01025 | Welders - Electric | 4 | EA | $3.60 | $86 | $13.20 | $317 |
| HET20 | Grout Pump Mixer | 2 | EA | $66.00 | $1,584 | $12.00 | $288 |
| HET17 | 4″ Submersible pump | 4 | EA | $4.32 | $104 | $9.36 | $225 |
| HED11 | Compressor 1200 cfm | 2 | EA | $21.60 | $518 | $37.25 | $894.00 |
| HCD11 | Aerial Lift, Self Prop | 2 | EA | $9.60 | $230 | $3.00 | $72 |
| HED13 | Hydraulic Track | 3 | EA | $54.00 | $1,296 | $79.74 | $1,914 |
| | w/12′ Feed | | | | | | |
| HED14 | 2″ Submersible pump - | 6 | EA | $1.44 | $35 | $0.86 | $21 |
| | 2 Hp | | | | | | |
| HCD12 | Concrete pump | 1 | EA | $33.00 | $792 | | |
| HCD12 | Concrete pump | 1 | EA | $33.00 | $792 | | |
| HCD13 | Form Carrier | 2 | EA | $— | $— | $2.20 | $53 |
| HET11 | Loco 35 Ton | 2 | EA | $72.00 | $1,728 | $1,728.00 | $432 |
| | Total cost perdays | | | | $7,396 | | $4,287 |
| | Average per day | | | | | | |
| | Average hrly rate | | | | $308 | | $179 |

[symbol]

indicates data missing or illegible when filed

THE REDDI SYSTEM LLC
7. MATERIAL DATA

| | | | |
|---|---|---|---|
| Material code | Description | Unit | Unit price |

Job Materials

| | | | |
|---|---|---|---|
| JE1010 | Explosives | | |
| JE1011 | Powder Delivery Charge | DAY | $3,850.00 |
| JE1012 | Powder | LBS | $7.70 |
| JE1013 | Powder Caps | EA | $8.40 |
| JE1014 | Misc Blasting Supplies | BCY | $4.83 |
| JE1015 | Drill bits | LF | $1.80 |
| JC1010 | Forms | SF | $2.00 |
| JC1011 | Water stops | LF | $0.50 |
| JC1012 | Keyways | LF | $2.00 |
| JC1013 | Reinforcing Steel Waste @ +5% | LBS | $0.05 |
| | Waste | | |
| JC1014 | Pipe Rail & Supports | LF | $1.70 |

Permanent Material

| | | | |
|---|---|---|---|
| PE1010 | #9 Bar Rock Bolts w/Hardware, 368 | LF | $2.00 |
| | Each × 12′ Long | | |
| PE1011 | Steel ribs/Channel W8 × 48, 8 Each | LBS | $5.00 |
| PE1012 | Steel rib plates, bolts and accessories | LBS | $5.00 |
| PE1013 | Permanent Shotcrete, SFR | CY | $105.00 |
| PC1010 | 2000 PSI Lean Concrete | CY | $90.00 |
| PC1011 | Water stops | LF | $2.00 |
| PC1012 | Asphalt Impregnated Protection | SF | $0.15 |
| | Board, ¼″ Thick (+10% | | |
| | Waste) | | |
| PC1013 | PVC Waterproofing Geomembrane, | SF | $1.50 |
| | 2.50 mm Thick (+10% Waste) | | |
| PC1014 | Reinforcing Steel | LBS | $0.45 |
| PC1015 | Rebar Placing Accessories | LBS | $0.05 |
| PC1016 | Concrete, 5000 PSI | CY | $130.00 |
| PC1017 | Miscellaneous Concrete Supplies | CY | $13.50 |
| PC1018 | Cement | SF | $1.70 |

The Reddi System LLC
Labor Data

| CODE | TITLE |
|---|---|
| LE0310 | ELECTRICIAN FOREMAN |
| LE0310 | ELECTRICIAN JOURNEYMAN |
| | LOCALS 14, 15 & 15 D OPERATORS |
| | OVERTIME RATES: 2.0 × HOURLY RATE & FRINGE BENEFITS AFTER 8-HR/WEEK- [symbol] |
| | TITLE |
| | LOCAL 14 |
| LE14010 | TOWER CRANE, CLIMBING CRANE |
| LE14010 | BACKHOES |
| LE14011 | MINE HOISTS & CRANES |
| LE14012 | GRADALLS, KEYSTONES, CRANES |
| LE14013 | PILE DRIVERS & RIG |
| LE14014 | TUNNEL MUCKING MACHINES, BACKFILLING MACHINES, CRANES |
| LE14015 | PAVERS, CABLEWAYS, LAND DERRICKS, POWER HOUSES |
| LE14016 | ELEVATORS |
| LE14017 | POWER HOUSES |
| LE14019 | PORTABLE COMPRESSORS |
| LE14019 | ROLLERS, CONCRETE MIXERS |
| LE14020 | CONCRETE BREAKING MACHINES, SINGLE DRUM HOISTS, |
| | LOCOMOTIVE (over 10 tons), CHERRYPICKER (Non-Operator) |
| LE14021 | RIVER COFFERDAM PUMPS, WELDING MACHINES |
| LE14022 | STATIONARY ENGINEERS |
| LE14023 | VIBRATORY HAMMER CONSOLE OPERATOR, ON-SITE ASPHALT & |
| | CONCRETE PLANT CONSOLE OPERATOR |
| LE14024 | AIR DRILLS |
| LE14025 | MASTER MECHANIC/SHOP STEWARD |
| | LOCAL 15 |
| LE15010 | JUNIOR ENGINEER |
| LE15011 | JUNIOR ENGINEER |
| LE15012 | MAINTENANCE ENGINEER TOWER CRANE |
| LE15013 | MAINTENANCE ENGINEER |
| LE15014 | MAINTENANCE ENGINEER |
| LE15015 | JUNIOR ENGINEER |
| LE15016 | JUNIOR ENGINEER |
| LE15017 | APPRENTICE ENGINEER & OILER |
| LE15018 | APPRENTICE ENGINEER & OILER |
| | LOCAL 15-C |
| LE15C10 | WORKING FOREMAN |
| LE15C11 | MECHANIC |
| LE15C12 | HELPER |
| | LOCAL 15-D |
| LE15D10 | PARTY CHIEF |
| LE15D11 | INSTRUMENT MAN |
| LE15D12 | RODMAN |

| | | | TL A-O | | | Total |
|---|---|---|---|---|---|---|
| | | | (ADJUSTED | TAX | | (TOTAL |
| | | WAGES | NON- | (ADJUSTED | Total Taxable | NON- |
| | | (ADJUSTED | TAXABLE | TAXABLE | (TOTAL | TAXABLE + |
| WAGES | HOL. | BASE | BENEFIT | BENEFIT | TAXABLE | TAXABLE |
| (BASE | (NUMBER | HOURLY | HOURLY | HOURLY | HOURLY | HOURLY |
| HOURLY | OF | RATE | RATE | RATE | BASE RATE + | BASE RATE + |
| RATE) | HOLIDAYS) | w/HOLIDAYS | w/HOLIDAYS | w/HOLIDAYS | BENEFITS) | BENEFITS) |
| 47.00 | 8 | 48.49 | 28.90 | 7.97 | 56.46 | 85.35 |
| 44.00 | 8 | 45.40 | 28.90 | 7.97 | 53.36 | 82.26 |

[symbol]

AY & ON SATURDAYS, SUNDAYS & HOLIDAYS

| | | | TL A-O | TAX | Total Taxable | Total |
|---|---|---|---|---|---|---|
| | | WAGES | NON- | TAXABLE | (TOTAL | NON- |
| WAGES | HOL. | BASE | TAXABLE | BENEFIT | TAXABLE | TAXABLE + |
| (BASE | (NUMBER | HOURLY | BENEFIT | HOURLY | HOURLY | TAXABLE |
| HOURLY | OF | RATE | HOURLY | RATE | BASE RATE + | HOURLY |
| RATE) | HOLIDAYS) | w/HOLIDAYS | RATE | w/HOLIDAY | BENEFITS) | BASE RATE |
| 64.07 | 11 | 66.90 | 23.91 | 0.00 | 66.90 | 90.81 |
| 52.89 | 11 | 55.23 | 23.91 | 0.00 | 55.23 | 79.14 |
| 54.54 | 11 | 56.95 | 23.91 | 0.00 | 56.95 | 80.86 |
| 53.28 | 11 | 55.63 | 23.91 | 0.00 | 55.63 | 79.55 |
| 52.23 | 11 | 54.54 | 23.91 | 0.00 | 54.54 | 78.45 |
| 51.08 | 11 | 53.34 | 23.91 | 0.00 | 53.34 | 77.25 |
| 49.63 | 11 | 51.82 | 23.91 | 0.00 | 51.82 | 75.73 |
| 43.42 | 11 | 45.34 | 23.91 | 0.00 | 45.34 | 69.25 |
| 48.56 | 11 | 50.71 | 23.91 | 0.00 | 50.71 | 74.62 |
| 33.79 | 11 | 35.28 | 23.91 | 0.00 | 35.28 | 59.19 |
| 48.33 | 11 | 50.47 | 23.91 | 0.00 | 50.47 | 74.38 |
| 44.35 | 11 | 46.31 | 23.91 | 0.00 | 46.31 | 70.22 |
| 31.40 | 11 | 32.79 | 23.91 | 0.00 | 32.79 | 56.70 |
| 40.93 | 11 | 42.74 | 23.91 | 0.00 | 42.74 | 66.65 |
| 44.72 | 11 | 46.70 | 23.91 | 0.00 | 46.70 | 70.61 |
| 50.15 | 11 | 52.37 | 23.91 | 0.00 | 52.37 | 76.28 |
| 53.86 | 11 | 56.23 | 23.91 | 0.00 | 56.23 | 80.15 |
| 48.55 | 11 | 50.69 | 20.99 | 1.57 | 52.26 | 73.25 |
| 47.19 | 11 | 49.27 | 20.99 | 1.57 | 50.84 | 71.83 |
| 60.73 | 11 | 63.41 | 20.99 | 1.57 | 64.98 | 85.97 |
| 46.99 | 11 | 49.07 | 20.99 | 1.57 | 50.63 | 71.62 |
| 32.83 | 11 | 34.28 | 20.99 | 1.57 | 35.85 | 56.83 |
| 44.94 | 11 | 46.93 | 20.99 | 1.57 | 48.49 | 69.48 |
| 32.10 | 11 | 33.52 | 20.99 | 1.57 | 35.08 | 56.07 |
| 42.67 | 11 | 44.56 | 20.99 | 1.57 | 46.12 | 67.11 |
| 30.49 | 11 | 31.84 | 20.99 | 1.57 | 33.40 | 54.39 |
| 36.51 | 11 | 38.12 | 19.90 | 1.78 | 39.90 | 59.80 |
| 35.16 | 11 | 36.71 | 19.90 | 1.78 | 38.49 | 58.39 |
| 31.32 | 11 | 32.70 | 19.90 | 1.78 | 34.48 | 54.38 |
| 49.63 | 11 | 51.82 | 20.00 | 1.57 | 53.39 | 73.38 |
| 36.44 | 11 | 38.05 | 20.99 | 1.57 | 39.62 | 60.60 |
| 31.65 | 11 | 33.05 | 20.99 | 1.57 | 34.61 | 55.60 |

| | FUI TAX | SUI TAX | | | | |
|---|---|---|---|---|---|---|
| FICA TAX | (0.80% ON | (9.90% ON | TOTAL TAX | | | |
| (7.65% OF | FIRST | FIRST | | (PERCENTAGE | | |
| TOTAL | $7,000/YR | $8,500/YR | | RATE OF | | |
| TAXABLE | HOURLY | HOURLY | | TOTAL | WC | |
| HOURLY | RATE- | RATE- | (TOTAL | TAXABLE | (WORKER'S | |
| BASE | FIG. 2 | FIG. 2 | TAX | HOURLY | COMPENSATION | TOTAL |
| RATE + | TURNOVER | TURNOVER | HOURLY | BASE RATE + | INSURANCE | HOURLY |
| BENEFITS) | S/YR) | S/YR) | RATE) | BENEFITS) | @ 20%) | RATE |
| 4.32 | 0.05 | 0.81 | 5.18 | 9.18% | 9.40 | 90.54 |
| 4.08 | 0.05 | 0.81 | 4.95 | 9.27% | 8.80 | 87.20 |

| FICA TAX | FUI TAX | SUI TAX | TOTAL TAX | | | |
|---|---|---|---|---|---|---|
| TOTAL | FIRST | FIRST | | E RATE OF | WC | |
| TAXABLE | $7,000/YR | $8,500/YR | (TOTAL | TOTAL | (WORKER'S | |
| HOURLY | HOURLY | HOURLY | TAX | TAXABLE | COMPENSATION | TOTAL |
| BASE | RATE- | RATE- | HOURLY | HOURLY | INSURANCE | HOURLY |
| RATE + | FIG. 2 | FIG. 2 | RATE) | BASE RATE + | @ 20%) | RATE |
| 5.12 | 0.05 | 0.81 | 5.98 | 8.94% | 12.81 | 96.79 |
| 4.22 | 0.05 | 0.81 | 5.09 | 9.21% | 10.58 | 84.23 |
| 4.36 | 0.05 | 0.81 | 5.22 | 9.17% | 10.91 | 86.08 |
| 4.26 | 0.05 | 0.81 | 5.12 | 9.20% | 10.66 | 84.66 |
| 4.17 | 0.05 | 0.81 | 5.04 | 9.23% | 10.45 | 83.48 |
| 4.08 | 0.05 | 0.81 | 4.94 | 9.27% | 10.22 | 82.19 |
| 3.96 | 0.05 | 0.81 | 4.83 | 9.32% | 9.93 | 80.56 |
| 3.47 | 0.05 | 0.81 | 4.33 | 9.55% | 8.68 | 73.58 |
| 3.88 | 0.05 | 0.81 | 4.74 | 9.35% | 9.71 | 79.36 |
| 2.70 | 0.05 | 0.81 | 3.56 | 10.10% | 6.76 | 62.76 |
| 3.86 | 0.05 | 0.81 | 4.72 | 9.36% | 9.67 | 79.10 |
| 3.54 | 0.05 | 0.81 | 4.41 | 9.51% | 8.87 | 74.63 |
| 2.51 | 0.05 | 0.81 | 3.37 | 10.28% | 6.28 | 60.07 |
| 3.27 | 0.05 | 0.81 | 4.13 | 9.67% | 8.19 | 70.78 |
| 3.57 | 0.05 | 0.81 | 4.44 | 9.50% | 8.94 | 75.04 |
| 4.01 | 0.05 | 0.81 | 4.87 | 9.30% | 10.03 | 81.15 |
| 4.30 | 0.05 | 0.81 | 5.16 | 9.18% | 10.77 | 85.31 |
| 4.00 | 0.05 | 0.81 | 4.86 | 9.30% | 9.71 | 78.11 |
| 3.89 | 0.05 | 0.81 | 4.75 | 9.35% | 9.44 | 76.58 |
| 4.97 | 0.05 | 0.81 | 5.83 | 8.98% | 12.15 | 91.80 |
| 3.87 | 0.05 | 0.81 | 4.74 | 9.35% | 9.40 | 76.36 |
| 2.74 | 0.05 | 0.81 | 3.61 | 10.06% | 6.57 | 60.44 |
| 3.71 | 0.05 | 0.81 | 4.57 | 9.43% | 8.99 | 74.05 |
| 2.68 | 0.05 | 0.81 | 3.55 | 10.11% | 6.42 | 59.62 |
| 3.53 | 0.05 | 0.81 | 4.39 | 9.52% | 8.53 | 71.50 |
| 2.56 | 0.05 | 0.81 | 3.42 | 10.23% | 6.10 | 57.81 |
| 3.05 | 0.05 | 0.81 | 3.92 | 9.81% | 7.30 | 63.72 |
| 2.94 | 0.05 | 0.81 | 3.81 | 9.89% | 7.03 | 62.20 |
| 2.64 | 0.05 | 0.81 | 3.50 | 10.15% | 6.26 | 57.88 |
| 4.08 | 0.05 | 0.81 | 4.95 | 9.27% | 9.93 | 78.33 |
| 3.03 | 0.05 | 0.81 | 3.89 | 9.83% | 7.29 | 64.50 |
| 2.65 | 0.05 | 0.81 | 3.51 | 10.14% | 6.33 | 59.11 |

WITHOUT WORKER'S COMPENSATION INSURANCE

| | OVERTIME RATES | | | | | | |
|---|---|---|---|---|---|---|---|
| | | | (2 TIMES | 5 DAY | | 6 DAY | AVERAGE |
| TOTAL 8- | (1.5 | | HOURLY | WORK | 6TH DAY | WORK | HOURLY RATE |
| HOUR | TIMES | (2 TIMES | RATE & | WEEK - | PREMIUM - | WEEK - | (6 DAY WORK |
| DAILY | HOURLY | HOURLY | FRINGE | SINGLE | SINGLE | SINGLE | WEEK - SINGLE |
| RATE | RATE) | RATE) | BENEFITS) | SHIFT | SHIFT | SHIFT | SHIFT) |
| 724.28 | 112.21 | | | 3,621.41 | 897.69 | 4,519.09 | 94.15 |
| 697.63 | 107.37 | | | 3,488.13 | 858.93 | 4,347.06 | 90.56 |

WITHOUT WORKER'S COMPENSATION INSURANCE

| | OVERTIME RATES | | | | | | |
|---|---|---|---|---|---|---|---|
| | | | (2 TIMES | 5 DAY | | 6 DAY | AVERAGE |
| TOTAL 8- | (1.5 | | HOURLY | WORK | 6TH DAY | WORK | HOURLY RATE |
| HOUR | TIMES | (2 TIMES | RATE & | WEEK - | PREMIUM - | WEEK - | (6 DAY WORK |
| DAILY | HOURLY | HOURLY | FRINGE | SINGLE | SINGLE | SINGLE | WEEK - SINGLE |
| RATE | RATE) | RATE) | BENEFITS) | SHIFT | SHIFT | SHIFT | SHIFT) |
| 774.34 | | | 191.86 | 3,871.72 | 1,534.88 | 5,406.60 | 112.64 |
| 673.81 | | | 166.73 | 3,369.04 | 1,333.81 | 4,702.85 | 97.98 |
| 688.65 | | | 170.44 | 3,443.23 | 1,363.48 | 4,806.71 | 100.14 |
| 677.31 | | | 167.60 | 3,386.57 | 1,340.82 | 4,727.40 | 98.49 |
| 667.87 | | | 165.24 | 3,339.36 | 1,321.94 | 4,661.30 | 97.11 |
| 657.53 | | | 162.66 | 3,287.66 | 1,301.26 | 4,588.91 | 95.60 |
| 644.49 | | | 159.40 | 3,222.46 | 1,275.18 | 4,497.64 | 93.70 |
| 588.65 | | | 145.44 | 2,943.25 | 1,163.49 | 4,106.74 | 85.56 |
| 634.87 | | | 156.99 | 3,174.35 | 1,255.93 | 4,430.28 | 92.30 |
| 502.05 | | | 123.79 | 2,510.26 | 990.30 | 3,500.56 | 72.93 |
| 632.80 | | | 156.47 | 3,164.01 | 1,251.80 | 4,415.81 | 92.00 |
| 597.01 | | | 147.53 | 2,985.06 | 1,180.22 | 4,165.28 | 86.78 |
| 480.56 | | | 118.41 | 2,402.80 | 947.31 | 3,350.11 | 69.79 |
| 566.26 | | | 139.84 | 2,831.29 | 1,118.71 | 3,950.00 | 82.29 |
| 600.34 | | | 148.36 | 3,001.70 | 1,186.87 | 4,188.57 | 87.26 |
| 649.17 | | | 160.57 | 3,245.84 | 1,284.53 | 4,530.37 | 94.38 |
| 682.49 | | | 168.90 | 3,412.43 | 1,351.16 | 4,763.59 | 99.24 |
| 624.88 | | | 154.49 | 3,124.40 | 1,235.95 | 4,360.35 | 90.84 |
| 612.65 | | | 151.44 | 3,063.25 | 1,211.49 | 4,274.74 | 89.06 |
| 734.41 | | | 181.88 | 3,672.04 | 1,455.01 | 5,127.05 | 106.81 |
| 610.85 | | | 150.99 | 3,054.26 | 1,207.90 | 4,262.15 | 88.79 |
| 483.52 | | | 119.15 | 2,417.59 | 953.23 | 3,370.82 | 70.23 |
| 592.42 | | | 146.38 | 2,962.08 | 1,171.03 | 4,133.11 | 86.11 |
| 476.95 | | | 117.51 | 2,384.77 | 940.10 | 3,324.87 | 69.27 |
| 572.00 | | | 141.28 | 2,860.02 | 1,130.20 | 3,990.22 | 83.13 |
| 462.48 | | | 113.89 | 2,312.38 | 911.14 | 3,223.52 | 67.16 |
| 509.72 | | | 125.70 | 2,548.61 | 1,005.64 | 3,554.24 | 74.05 |
| 497.58 | | | 122.67 | 2,487.91 | 981.36 | 3,469.26 | 72.28 |
| 463.05 | | | 114.04 | 2,315.25 | 912.29 | 3,227.55 | 67.24 |
| 626.66 | | | 154.94 | 3,133.28 | 1,239.50 | 4,372.78 | 91.10 |
| 515.98 | | | 127.27 | 2,579.91 | 1,018.15 | 3,598.06 | 74.96 |
| 472.91 | | | 116.50 | 2,364.54 | 932.01 | 3,296.54 | 68.68 |

WITH WORKER'S COMPENSATION INSUR

[symbol]

| | TOTAL 8- | OVERTIME RATES | | |
|---|---|---|---|---|
| TOTAL | HOUR | | (2 TIMES | |
| HOURLY | DAILY | | HOURLY | (2 TIMES HOURLY RATE |
| RATE | RATE | (1.5 TIMES HOURLY RATE) | RATE) | & FRINGE BENEFITS) |
| 99.94 | 799.48 | 126.31 | | |
| 96.00 | 768.03 | 120.57 | | |

WITH WORKER'S COMPENSATION INSUR

[symbol]

| | TOTAL 8- | OVERTIME RATES | | |
|---|---|---|---|---|
| TOTAL | HOUR | | (2 TIMES | |
| HOURLY | DAILY | | HOURLY | (2 TIMES HOURLY RATE |
| RATE | RATE | (1.5 TIMES HOURLY RATE) | RATE) | & FRINGE BENEFITS) |
| 109.61 | 876.86 | | | 217.49 |
| 94.80 | 758.43 | | | 187.88 |
| 96.99 | 775.91 | | | 192.25 |
| 95.32 | 762.56 | | | 188.91 |
| 93.93 | 751.44 | | | 186.13 |
| 92.41 | 739.26 | | | 183.09 |
| 90.49 | 723.90 | | | 179.25 |
| 82.27 | 658.12 | | | 162.80 |
| 89.07 | 712.57 | | | 176.42 |
| 69.51 | 556.12 | | | 137.30 |
| 88.77 | 710.13 | | | 175.81 |
| 83.50 | 667.97 | | | 165.27 |
| 66.35 | 530.80 | | | 130.97 |
| 78.97 | 631.75 | | | 156.21 |
| 83.99 | 671.89 | | | 166.25 |
| 91.18 | 729.41 | | | 180.63 |
| 96.08 | 768.65 | | | 190.44 |
| 87.82 | 702.56 | | | 173.91 |
| 86.02 | 688.15 | | | 170.31 |
| 103.95 | 831.58 | | | 206.17 |
| 85.75 | 686.04 | | | 169.78 |
| 67.01 | 536.05 | | | 132.29 |
| 83.04 | 664.32 | | | 164.35 |
| 66.04 | 528.31 | | | 130.35 |
| 80.03 | 640.28 | | | 158.34 |
| 63.91 | 511.26 | | | 126.09 |
| 71.02 | 568.14 | | | 140.31 |
| 69.23 | 553.84 | | | 136.73 |
| 64.15 | 513.16 | | | 126.56 |
| 88.26 | 706.06 | | | 174.79 |
| 71.79 | 574.29 | | | 141.85 |
| 65.44 | 523.55 | | | 129.16 |

[symbol]

ANCE

| | | 6 DAY | 5 DAY |
|---|---|---|---|
| | | WORK | WORK |
| 5 DAY WORK | 6TH DAY | WEEK - | WEEK - |
| WEEK - | PREMIUM - | SINGLE | SINGLE |
| SINGLE SHIFT | SINGLE SHIFT | SHIFT | SHIFT |
| 3,997.41 | 1,010.49 | 5,007.89 | 99.94 |
| 3,840.13 | 964.53 | 4,804.66 | 96.00 |

[symbol]

ANCE

| | | 6 DAY | 5 DAY |
|---|---|---|---|
| | | WORK | WORK |
| 5 DAY WORK | 6TH DAY | WEEK - | WEEK - |
| WEEK - | PREMIUM - | SINGLE | SINGLE |
| SINGLE SHIFT | SINGLE SHIFT | SHIFT | SHIFT |
| 4,384.28 | 1,739.90 | 6,124.18 | 109.61 |
| 3,792.16 | 1,503.06 | 5,295.21 | 94.80 |
| 3,879.55 | 1,538.01 | 5,417.56 | 96.99 |
| 3,812.81 | 1,511.32 | 5,324.13 | 95.32 |
| 3,757.20 | 1,489.07 | 5,246.28 | 93.93 |
| 3,696.30 | 1,464.71 | 5,161.01 | 92.41 |
| 3,619.50 | 1,433.99 | 5,053.49 | 90.49 |
| 3,290.61 | 1,302.43 | 4,593.04 | 82.27 |
| 3,562.83 | 1,411.33 | 4,974.16 | 89.07 |
| 2,780.58 | 1,098.42 | 3,879.00 | 69.51 |
| 3,550.65 | 1,406.45 | 4,957.10 | 88.77 |
| 3,339.86 | 1,322.14 | 4,662.00 | 83.50 |
| 2,654.00 | 1,047.79 | 3,701.79 | 66.35 |
| 3,158.73 | 1,249.68 | 4,408.41 | 78.97 |
| 3,359.46 | 1,329.98 | 4,689.43 | 83.99 |
| 3,647.04 | 1,445.01 | 5,092.05 | 91.18 |
| 3,843.27 | 1,523.50 | 5,366.77 | 96.08 |
| | | | 0.00 |
| 3,512.80 | 1,391.31 | 4,904.11 | 87.82 |
| 3,440.77 | 1,362.50 | 4,803.27 | 86.02 |
| 4,157.88 | 1,649.34 | 5,807.22 | 103.95 |
| 3,430.18 | 1,358.26 | 4,788.44 | 85.75 |
| 2,680.23 | 1,058.28 | 3,738.52 | 67.01 |
| 3,321.60 | 1,314.83 | 4,636.44 | 83.04 |
| 2,641.57 | 1,042.82 | 3,684.39 | 66.04 |
| 3,201.38 | 1,266.74 | 4,468.12 | 80.03 |
| 2,556.30 | 1,008.71 | 3,565.01 | 63.91 |
| | | | 0.00 |
| 2,840.69 | 1,122.47 | 3,963.15 | 71.02 |
| 2,769.19 | 1,093.87 | 3,863.06 | 69.23 |
| 2,565.81 | 1,012.52 | 3,578.33 | 64.15 |
| | | | 0.00 |
| 3,530.32 | 1,398.32 | 4,928.64 | 88.26 |
| 2,871.43 | 1,134.76 | 4,006.19 | 71.79 |
| 2,617.74 | 1,033.29 | 3,651.02 | 76.06 |

[symbol]

indicates data missing or illegible when filed

It should be understood, of course, that the specific form of the invention herein illustrated and described is intended to be representative only, as certain changes may be made therein without departing from the clear teachings of the disclosure. Accordingly, reference should be made to the following appended claims in determining the full scope of the invention.

What is claimed:

1. A system for determining an escalated estimated project cost and an estimated schedule for a project including a plurality of activities, the system comprising:
a computer system having specialized programming for determining said escalated estimated cost and said estimated schedule for said project, based on said plurality of activities;
said computer system having means to receive an input from a user of said plurality of activities for said project, each activity having one or more cost items, and each activity including a number of days for completion, or information sufficient to compute said number of days for completion;
said computer system being operable to receive an input from said user of a start date of said project and, for each activity, an input of an amount of critical days to include on a critical path of said project out of said number of days for completion for each activity;
said computer system being operable to determine a critical path for said project based on said amount of critical days to include on said critical path for each activity;
said computer system being operable to determine a start date and a finish date for each activity based on said critical path;
said computer system being operable to determine a pre-escalation cost for each cost item of each activity, and to determine a pre-escalation cost for each activity by summing said pre-escalation costs for each cost item in each activity;
said computer system being operable to determine a pre-escalation total project cost by summing said pre-escalation cost for each activity;
said computer system being operable to determine a cost escalation for each activity;
said computer being operable to determine a cost escalation for said project by summing said cost escalation for each activity, and being operable to determine an escalated estimated cost of said project by summing said pre-escalation total project cost and said cost escalation for said project;
said computer system being operable to generate a report of said pre-escalation total project cost and said escalated estimated project cost; and
said computer system being operable to generate said estimated project schedule based on said critical path, as determined by the computer system.

2. The system as in claim 1, wherein to determine said escalated estimated project cost, said computer system is operable to:
determine a cost escalation for each cost item of each activity based on a cost escalation curve associated with each cost item; and
determine said cost escalation for each activity by summing said cost escalation for each cost item in each activity.

3. The system as in claim 2, wherein to determine said escalated estimated project cost, said computer system is operable to:
receive from said user a specification of an escalation curve for each one of a plurality of categories of cost items; and
employ an escalation curve specified for a category of cost items when determining said cost escalation a cost item within said specified category.

4. The system as in claim 3, wherein said plurality of categories of cost items includes equipment costs, fuel and lubrication costs, subcontractor costs, materials costs, and labor costs.

5. The system as in claim 1, wherein to determine said escalated estimated project cost, said computer system is operable to:
determine a mid-point of each activity based on said start and finish dates of each activity;
determine a duration from a base date to said mid-point of each activity, where said base date is selected by said user is a reference date used to determine pre-escalation costs for each cost item in each activity;
determine an escalation rate for each activity by multiplying a predetermined periodic escalation factor by said duration from said base date to said mid-point of each activity; and
determining a escalated cost for each activity by increasing said pre-escalation cost of each activity by said escalation rate for each activity.

6. The system as in claim 1, wherein,
said computer system is operable to receive, for each activity, indications from said user of necessary predecessor activities or necessary successor activities; and
said computer system is operable to determine a chronological order of activities based on said indications of said necessary predecessor or successor activities.
